(19) United States
(12) Patent Application Publication
(10) Pub. No.: US 2018/0217962 A1
(43) Pub. Date: Aug. 2, 2018

(54) OPERATION PROCESSING APPARATUS AND OPERATION PROCESSING METHOD

(71) Applicant: FUJITSU LIMITED, Kawasaki-shi (JP)

(72) Inventor: Jin Takahashi, Ota (JP)

(73) Assignee: FUJITSU LIMITED, Kawasaki-shi (JP)

(21) Appl. No.: 15/877,444

(22) Filed: Jan. 23, 2018

(30) Foreign Application Priority Data
Feb. 2, 2017 (JP) 2017-017668

(51) Int. Cl. G06F 17/15; G06N 5/04; G06T 1/20; G06F 9/30

(52) U.S. Cl. CPC G06F 17/153; G06N 5/046; G06F 9/30181; G06F 9/3004; G06T 1/20

(57) ABSTRACT

An operation processing apparatus includes: a processor; and a memory coupled to the processor and configured to store a program, the processor, according to the program, performs: acquiring first data and second data from the memory in which the first data and second data are stored, the first data including pieces of element data arranged in the form of a matrix, the second data having an arrangement form obtained by removing a specific number of pieces of element data from the pieces of element data; converting the first data based on the arrangement form of the second data; and executing a convolution operation on the converted first data using the second data as a filter.

### CROSS-REFERENCE TO RELATED APPLICATION

This application is based upon and claims the benefit of priority of the prior Japanese Patent Application No. 2017-017668, filed on Feb. 2, 2017, the entire contents of which are incorporated herein by reference.

### FIELD

The embodiments discussed herein are related to an operation processing apparatus and an operation processing method.

### BACKGROUND

A GPU (Graphic Processing Unit) used in an operation processing apparatus is a processor for image processing. The GPU includes many multiply-accumulate operation units and is optimized for a matrix calculation, and thus the GPU is also used as a processor for performing a machine learning process. Also in a deep learning process, the GPU is used.

A related technique is disclosed in Japanese Laid-open Patent Publication No. 2011-113168.

### SUMMARY

According to an aspect of the embodiments, an operation processing apparatus includes: a processor; and a memory coupled to the processor and configured to store a program, the processor, according to the program, performs: acquiring first data and second data from the memory in which the first data and second data are stored, the first data including pieces of element data arranged in the form of a matrix, the second data having an arrangement form obtained by removing a specific number of pieces of element data from the pieces of element data; converting the first data based on the arrangement form of the second data; and executing a convolution operation on the converted first data using the second data as a filter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a process in a convolutional neural network;

FIG. 2 illustrates an example of a forward convolution operation and an example of a backward convolution operation;

FIG. 3 illustrates an example of an operation processing layer;

FIG. 4 illustrates an example of a convolution operation unit configured to perform a forward convolution operation;

FIG. 5 illustrate examples of filter definitions;

FIG. 6 illustrates an example of a conversion of bottom data;

FIG. 7 illustrates an example of bottom data having been subjected to a conversion;

FIG. 8 illustrates an example of a conversion of bottom data;

FIG. 9 illustrates an example of a conversion of bottom data;

FIG. 10 illustrates an example of a forward convolution operation using a new filter definition;

FIG. 11 illustrates an example of a backward-convolution bottom-difference operation using a new filter definition;

FIG. 12 illustrates an example of a backward-convolution weight-difference operation using a new filter definition;

FIG. 13 illustrates an example of a process in an operation processing layer for a case where a new filter definition is used;

FIG. 14 illustrates an example of a forward convolution operation by a convolution operation unit;

FIG. 15 illustrates an example of a backward convolution operation by a convolution operation unit;

FIG. 16 illustrates an example of a pooling process by a pooling process unit for a case where the number of strides is two;

FIG. 17 illustrates an example of a pooling process by a pooling process unit for a case where the number of strides is one;

FIG. 18 illustrates an example of a forward convolution operation by a convolution operation unit;

FIG. 19 illustrates an example of a forward convolution operation by a convolution operation unit using a new filter definition;

FIG. 20 illustrates an example of a forward convolution operation by a convolution operation unit using a new filter definition;

FIG. 21 illustrates an example of a description of a program of a forward convolution operation;

FIG. 22 illustrates an example of a description of a program of a backward-convolution weight-difference operation;

FIG. 23 illustrates an example of a description of a program of a backward-convolution bottom-difference operation; and

FIG. 24 illustrates an example of a hardware configuration of an operation processing apparatus.

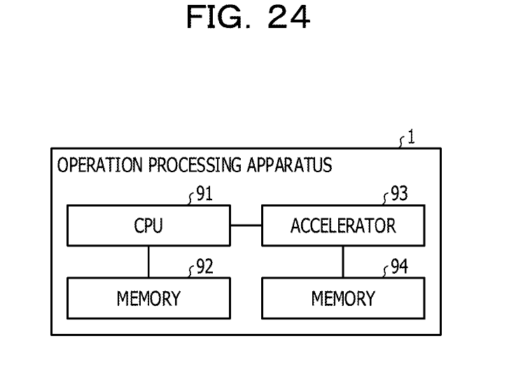

### DESCRIPTION OF EMBODIMENTS

In deep learning, in many cases, a process is performed using a neural network. For example, deep learning for image recognition includes following two processes: a forward process for determining what a given image is; and a backward process for updating parameters of the neural network used in the determination. An operation processing apparatus configured to perform deep learning performs the backward process using a difference between a calculation result in the forward process and an expectation value and updates parameters of the neural network. The operation processing apparatus improves the accuracy of the forward process using the updated parameters.

The neural network may include a plurality of layers. In the forward process performed in a forward propagation direction, an operation process such as extracting a feature value is performed on input data in each layer, and a result is output. In the backward process performed in a backward propagation direction, learning to update each parameter is performed sequentially, in a direction opposite to the forward propagation direction, in each layer using a difference of the result in the forward propagation from an expectation value. As described above, the neural network has a multilayer structure including a plurality of layers in which different operation processes are performed. In this structure, to update parameters on a layer-by-layer basis, learning is performed such that a difference of a calculation result in each layer from an expectation value is determined, and this difference is propagated to an immediately preceding layer, and a result of a difference calculation in the preceding layer is propagated to a further preceding layer, and so on. Note that in the present description, the direction of preceding” and the direction “following” are defined as seen in the forward propagation direction.

For example, deep learning operation processes used mainly in image recognition include a convolutional neural network process. In the convolutional neural network, an operation called convolution appears very frequently. Hereinafter, this operation will be referred to as a “convolution operation”. For example, in a case where image recognition is performed, a filter including predetermined parameters as filter elements is placed in an area of an original image. An input side in the forward propagation is called a bottom, and an output side is called a top. In the backward propagation, the positional relationship in the forward propagation is maintained, and thus an output side is called the bottom and an input side is called the top. Input data including an original image given to each layer in the forward propagation direction is referred to as “bottom data”. In a case where the convolution operation is performed in deep learning image recognition, the input data is in a bitmap format, and thus when the data is arranged sequentially in order, the resultant data arranged in this manner looks like an image having the same appearance as that of an actual image. Each piece of element data included in the input data represents an intensity level in a gray scale or an intensity level of one of three colors in RGB (Read Green Blue). The filter is called “weight data”.

By calculating the sum of products of the respective elements of the input data on which the filter is placed and the respective elements of the filter, a feature value of the area of the input data, where the filter is placed, is determined. The the filter on the original image is placed on an area-by-area while shifting the filter by a predetermined amount at a time until the whole area of the original image is covered, and calculated feature values are aggregated. The aggregated result is output as a result of the convolution operation, that is, output as output data. The output data obtained as the result of the convolution operation in the forward process is referred to as “top data”.

The convolution operation in the backward process includes to operations. One of them is an operation of calculating a difference parameter using an original image and a difference, from an expectation value, of top data obtained as a result of a calculation in the forward process. The difference of the top data obtained as the result of the calculation in the forward process from the expectation value is referred to as “top difference data”. The calculated difference parameter is referred to as “weight difference data”. The weight difference data is used in updating the weight data to increase the calculation accuracy in the forward process. The other one of the operations is an operation using top difference data and weight data to calculate a difference for use in an operation in a preceding backward process. The difference for use in the operation in the preceding backward process is referred to as “bottom difference data”. This bottom difference data is used as top difference data in a preceding layer.

For example, the total number of operations in the convolution operation is calculated as follows. Let it be assumed here by way of example that the number of pieces of element data of the bottom data is C′×C′, the number of pieces of bottom data is N, the number of pieces of element data of the weight data is K×K, the number of pieces of element data of the top difference data is C×C, and the number of pieces of top data is P. Furthermore, let it be assumed that one convolution operation in the forward process includes one multiplication operation and one addition operation. In this case, the total number of operations in the forward process is given by P×C×C×N×K×K×2. For example, in a case where C=13, N=256, K=3, C=13, and P=256, the total number of operations in the forward process is calculated as 256×13×13×256×3×3×2=1990360512. In a case where the size of the weight data is great, FFT (Fast Fourier Transform) is an effective processing acceleration method. However, in a case where the above condition is not met, it may be difficult to achieve acceleration effect by FFT. Therefore, in the convolution operation without being bounded by a particular condition, it may be difficult to reduce the number of operations while maintaining image recognition accuracy.

For example, an operation processing apparatus and a method of controlling an operation processing apparatus capable of reducing the number of operations while maintaining image recognition accuracy may be provided.

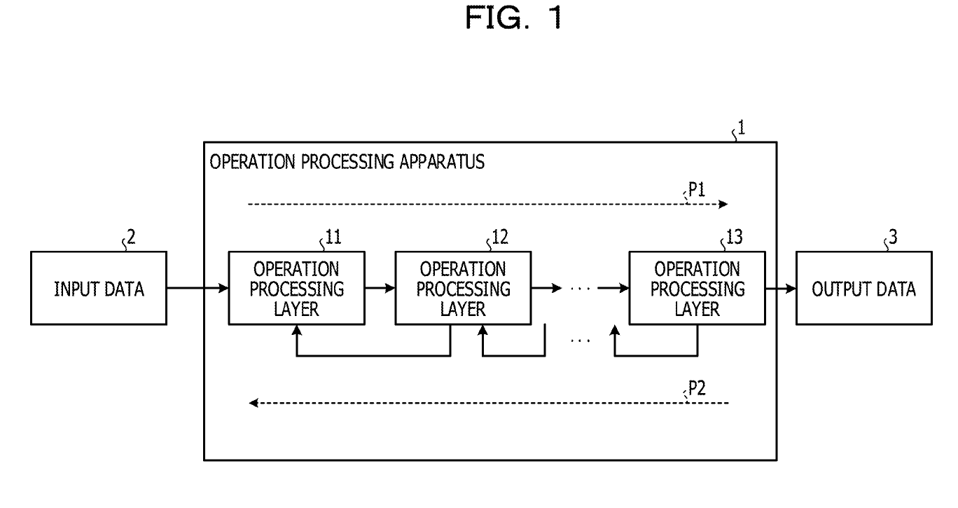

FIG. 1 illustrates an example of a process in CNN (Convolutional Neural Network). In FIG. 1, an overall flow is illustrated. As illustrated in FIG. 1, the operation processing apparatus 1 receives an input of input data 2. The operation processing apparatus 1 performs processes in a plurality of operation processing layers 11 to 13 in CNN for image recognition. Hereinafter, in a case where the operation processing layers 11 to 13 are not distinguished from each other. The operation processing layers 11 to 13 will be referred to simply as “operation processing layers 10”.

In each operation processing layer 10, an operation process such as a feature point extraction is performed in a propagation direction denoted by an arrow P1. Hereinafter, the operation process performed by the operation processing apparatus 1 in the direction denoted by the arrow P1 will also be referred to as a “forward operation”. In each operation processing layer 10, to increase feature point extraction accuracy in each layer, two types of operation processes are performed in a backward propagation direction denoted by an arrow P2. Hereinafter, the operation process performed by the operation processing apparatus 1 in the direction denoted by the arrow P2 will also be referred to as a “backward operation”.

Each operation processing layer 10 acquires weight data, functioning as a filter used in extracting a feature value, from a storage apparatus such as a memory. The operation processing layer 1, which is a first-layer operation processing layer, acquires input data 2 from the storage apparatus such as a memory. The operation processing layer 11 employs the input data 2 as bottom data and performs a convolution operation on the bottom data using the weight data. Next, the operation processing layer 12, which is a second-layer operation processing layer, employs output data from the operation processing layer 11 as bottom data and performs a bottom data on the bottom data using the weight data. The operation processing apparatus 1 performs the operation processes described above in the respective operation processing layers 10 sequentially from one layer to next, and the operation processing apparatus 1 outputs, as output data 3, data representing a feature value obtained by performing a normalization process or the like on an operation result of a convolution operation performed, using weight data, in the operation processing layer 13 which is an nth layer operation processing layer. Hereinafter, the convolution operation performed, in the forward operation, using bottom data and weight data will be referred to as a “forward convolution operation”.

Each operation processing layer 10 performs, as one of convolution operations in the backward operation, an operation to determine weight difference data using top difference data which a difference between the output data 3 and an expectation value. For example, the nth-layer operation processing layer 13 has a predetermined expectation value and compares the output data 3 with the expectation value. The operation processing layer 13 then determines top difference data which is a difference between the output data 3 and the expectation value, and acquires, as input data, the determined top difference data. Next, the operation processing layer 13 determines weight difference data, which is a difference between the weight data and the expectation value of the weight data, using the input data and the bottom data used in the forward convolution operation in the nth layer. The operation processing layer 13 then adjusts the weight data in the nth layer using the determined weight difference data. Furthermore, the operation processing layer 13 calculates, as the other one of the backward operations in the convolution operation, bottom difference data, which is a difference between the bottom data and the expectation value of the bottom data, using the difference between the adjusted weight data and the expectation value of the output data 3.

Next, an (n−1)th-layer operation processing layer 10 acquires, as top difference data, data obtained as a result of performing an inverse pooling process or an inverse normalization process on the bottom difference data calculated in the operation processing layer 13. Next, the (n−1)th-layer operation processing layer 10 calculates weight difference data using the top difference data and the bottom data used in the forward convolution operation in the (n−1)th layer. The (n−1)th-layer operation processing layer 10 adjusts the weight data in the (n−1)th layer using the determined weight difference data. Furthermore, the (n−1)th-layer operation processing layer 10 calculates bottom difference data in the (n−1)th layer using the adjusted weight data and the top difference data. The operation processing apparatus 1 repeats the above-described convolution operation in the backward operation until the convolution operation is completed for the first layer. Hereinafter, the convolution operation in the backward operation will be referred to as the “backward convolution operation”.

For example, in an operation processing layer 10 located one layer ahead of a particular operation processing layer 10 as seen in the layer arrangement direction defined by the direction denoted by the arrow P1, the operation processing apparatus 1 calculates top difference data for the particular operation processing layer 10. Using the calculated top difference data and bottom data which is output data from an immediately preceding operation processing layer 10, the operation processing apparatus 1 determines weight difference data for the particular operation processing layer 10. Using the determined weight difference data in the particular operation processing layer 10, the operation processing apparatus 1 adjusts the weight data for use in the particular operation processing layer 10. The operation processing apparatus 1 calculates top difference data and bottom difference data in the particular operation processing layer 10.

Hereinafter, in the backward convolution operation, the operation of determining weight difference data using top difference data and bottom data will be referred to as a “backward-convolution weight-difference operation”, and the operation of calculating the bottom difference data using the adjusted weight data and the top difference data will be referred to as a “backward-convolution bottom-difference operation”.

The operation processing apparatus 1 performs the process of adjusting the weight data and calculating top difference data in the immediately preceding operation processing layer sequentially from one layer to another in the operation processing layers 10 thereby adjusting the weight data for all layers of the operation processing layers 10 based on the expectation value of the output data 3 of the operation processing layer 13.

By performing learning to repeatedly update parameters using feature values acquired in the respective layer, the operation processing apparatus 1 is capable of improving the image recognition accuracy thereby achieving high accuracy in the image recognition. In the case of speech recognition, the input data 2 voice data, while in the case of text mining, the input data 2 is a word.

For example, when the bottom data is image data, the bottom data includes pieces of element data arranged in the form of a rectangular matrix. Hereinafter, the amount of shifting of weight data at a time in the forward convolution operation will also be referred to as the “number of strides”.

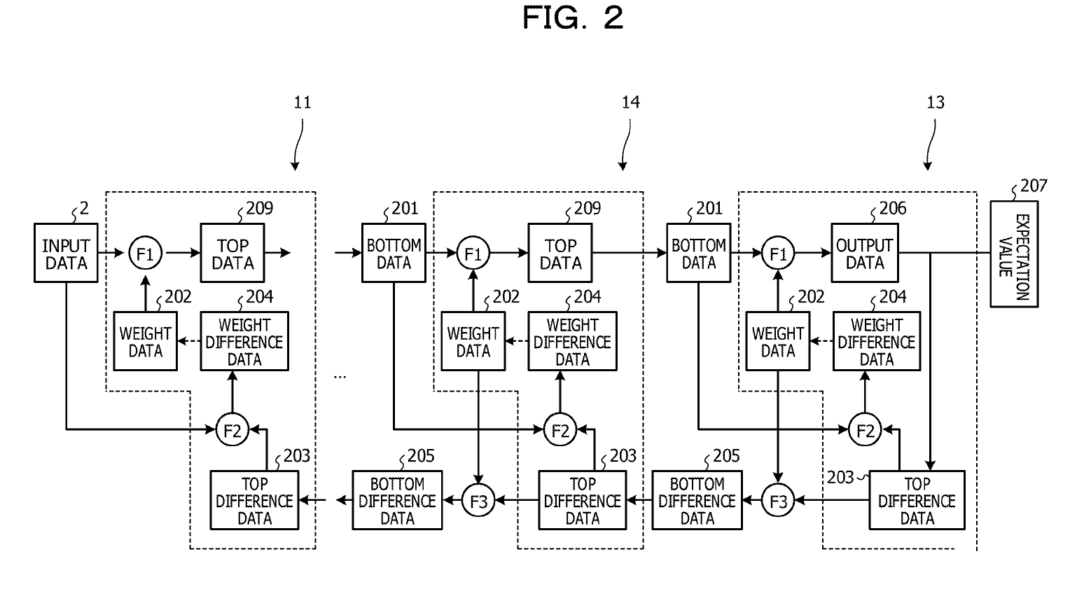

FIG. 2 illustrates an example of a forward convolution operation and an example of a backward convolution operation. In first to nth layers illustrated in FIG. 2, the operation process is started in the first layer using input data 2, and top difference data 203 is produced in the nth layer using output data 206 and an expectation value 207. Here it is assumed by way of example that the operation processing layer 11 is the first layer, the operation processing layer 14 is the (n−1)th layer, and the operation processing layer 13 is the nth layer. In this configuration including the first to nth layers, operations are performed in the respective operation processing layers 11 to 14. In FIG. 2, respective circles denote operation processes. More specifically, operation processes F1 each denote a forward convolution operation, operation processes F2 each denote a backward-convolution weight-difference operation, and operation processes F3 each denote a backward-convolution bottom-difference operation.

In the operation processing layer 11, the operation processing apparatus 1 performs a forward convolution operation denoted by the operation process F1 on the input data 2 and the weight data 202 in the first layer thereby calculating top data 209. Thereafter, similarly, in the next second layer, a forward convolution operation denoted similarly by the operation process F1 is performed on bottom data 201 acquired from the top data 209 calculated in the preceding layer and weight data 202 in the second layer. In the respective operation processing layers 10, the forward operation is repeated in a similar manner sequentially from one layer to next layer. In the final layer, that is, in the nth-layer operation processing layer 13, similarly, a forward convolution operation denoted by the operation process F1 is performed on bottom data 201 acquired from top data 209 calculated in the operation processing layer 14 and weight data 202 in the nth layer.

The operation processing layer 13 calculates top difference data 203 by comparing the output data 3 with the expectation value 207. The input data 2 corresponds to the bottom data 201 in each of the layers from the second layer to the nth layer, and thus hereafter the input data 2 is treated as the bottom data 201 in the first layer. The output data 3 in the nth layer corresponds to the top data 209 in each of the layers from the first layer to the (n−1)th layer.

In the backward operation, the operation processing layer 13 performs the backward-convolution weight-difference operation denoted by the operation process F2 on the top difference data 203 and the bottom data 201 thereby calculating weight difference data 204. The operation processing layer 13 updates the weight data 202 using the weight difference data 204. In FIG. 2, an arrow represented by a dot-dash line indicates the process of updating the weight data 202. For example, the operation processing apparatus 1 multiplies the weight difference data 204 by a learning rate and employs the result as new weight data 202. The operation processing layer 13 performs the backward-convolution bottom-difference operation denoted by the operation process F3 on the weight data 202 used in the forward convolution operation and the top difference data 203 thereby calculating bottom difference data 205.

The operation processing layer 14 performs a backward-convolution weight-difference operation denoted by the operation process F2 on top difference data 203 acquired from the bottom difference data 205 output from the operation processing layer 13 and the bottom data 201 thereby calculating weight difference data 204. The operation processing layer 14 updates the weight data 202 using the weight difference data 204. The operation processing layer 14 performs a backward-convolution bottom-difference operation denoted by the operation process F3 on the weight data 202 used in the forward convolution operation and the top difference data 203 thereby calculating bottom difference data 205. In the respective operation processing layers 10, the backward operation is repeated in a similar manner sequentially from one layer to next layer. In the final layer, that is, in the first-layer operation processing layer 11, the backward-convolution weight-difference operation and the backward-convolution bottom-difference operation are performed in a similar manner using top difference data 203 acquired from the bottom difference data 205 calculated in the second layer.

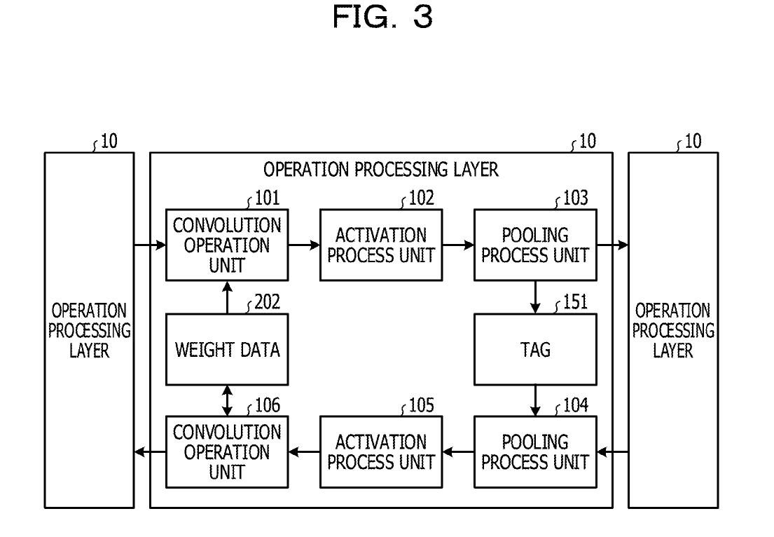

FIG. 3 illustrates an example of an operation processing layer. The operation processing layer 10 includes, as functional units for executing the forward operation, a convolution operation unit 101, an activation process unit 102, and a pooling process unit 103. The operation processing layer 10 also includes, as functional units for executing the backward operation, a pooling process unit 104, an activation process unit 105, and a convolution operation unit 106.

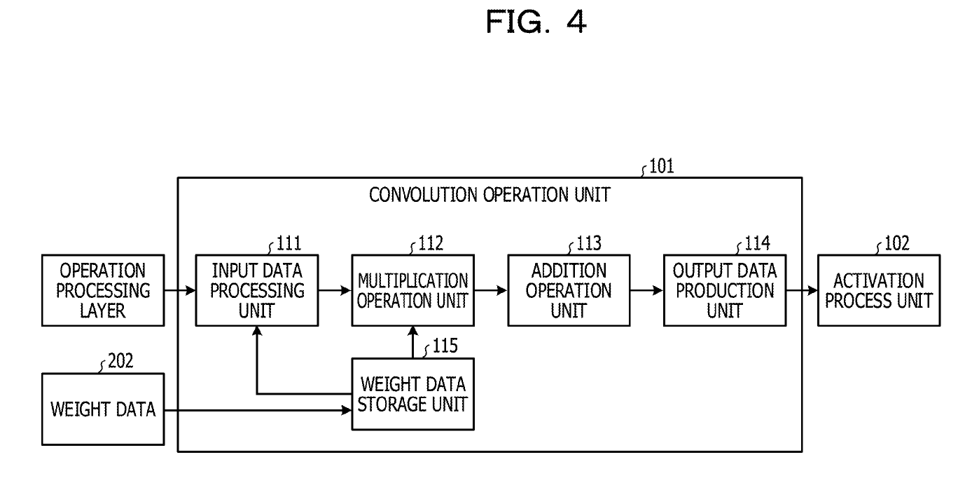

The convolution operation unit 101 performs the convolution operation using output data from a preceding operation processing layer 10. FIG. 4 illustrates an example of a convolution operation unit configured to perform the forward convolution operation. As illustrated in FIG. 4, the convolution operation unit 101 includes an input data processing unit 111, a multiplication operation unit 112, an addition operation unit 113, output data production unit 114, and a weight data storage unit 115.

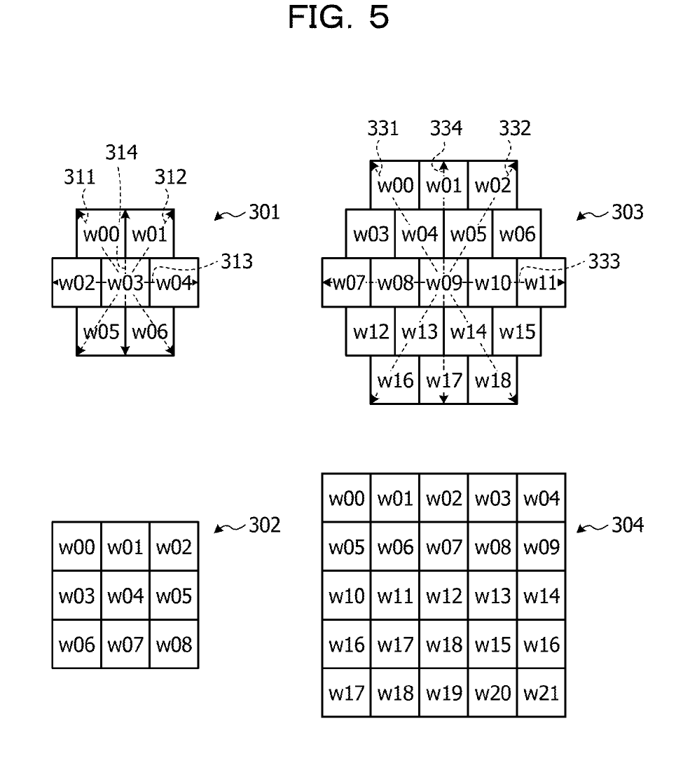

The weight data storage unit 115 stores weight data 202 corresponding to a plurality of filter definitions for use in the forward convolution operation. More specifically, the weight data storage unit 115 stores weight data 222 produced using a new filter definition 301 and a filter definition 302 illustrated in FIG. 5. FIG. 5 illustrate examples of filter definitions. The filter definition 302 is a filter definition having a 3×3 size. The filter definition 302 may be a conventional filter definition. The new filter definition 301 is a new filter definition corresponding to the filter definition 302.

The new filter definition 301 is symmetrical about the center in directions along axes 311 to 314. For example, the new filter definition 301 is symmetric in vertical, horizontal, and diagonal directions, respectively, which makes it possible to achieve high accuracy in image recognition in the vertical, horizontal, and diagonal directions of an image. Therefore, the new filter definition 301 has a small reduction in image recognition accuracy compared with the accuracy achieved when the filter definition 302 is used, and the new filter definition 303 can provide sufficient accuracy in image recognition.

The weight data 202 with a size of 3×3 is used. However, the weight data storage unit 115 may store weight data 202 with a different size. For example, the weight data storage unit 115 may store a new filter definition 303 and a filter definition 304. The filter definition 304 is a filter definition with a 5×5 size. The filter definition 304 may be a conventional filter definition. The new filter definition 303 is a new filter definition corresponding to the filter definition 304. The new filter definition 303 is also symmetric about the center in directions along axes 331 to 334. For example, the new filter definition 303 has a small reduction in image recognition accuracy compared with the accuracy achieved when the filter definition 304 is used, and the new filter definition 303 can provide sufficient accuracy in image recognition. The new filter definition 301 or 303 has an arrangement form achieved, from a state in which a plurality of pieces of element data are equally arranged in the row and column directions, by removing one piece of element data from each row from one row to a next row in a direction apart from a center row, and by shifting the element data positions in the row direction such that the center of each row is located at the same position as that in the state in which the one piece of element data is not yet removed.

The two types of filter definitions, that is, the new filter definition 301 and 303 have been described above. Note that the new filter definitions are not limited to these examples, but other filter definitions may be employed as long as the number of pieces of element data is smaller than that of the conventional filter definition such as the filter definition 302 or 304. It is preferable that the new filter definition is symmetric about the center in the vertical, horizontal, and diagonal directions. Hereinafter, the weight data 202 produced using the new filter definition 301 will be referred to as “weight data 221”.

The input data processing unit 111 receives an input of the bottom data 201 from an operation processing layer 10 at a preceding layer in the forward operation. This bottom data 201 is an example of “first data”. The input data processing unit 111 then acquires the weight data 202 from the weight data storage unit 115. Next, the input data processing unit 111 determines, from an instruction input by an operator via the input apparatus, whether the new filter definition 301 is to be used in an image determination. In a case where the new filter definition 301 is not to be used, the input data processing unit 111 notifies the multiplication operation unit 112 that the weight data 202 produced using the filter definition 302 is to be used, and the input data processing unit 111 outputs bottom data.

In a case where the new filter definition 301 is to be used, the input data processing unit 111 determines whether the input bottom data 201 is data compatible with the new filter definition 301. In a case where the bottom data 201 is data compatible with the new filter definition 301, the input data processing unit 111 notifies the multiplication operation unit 112 that the weight data 221 produced using the new filter definition 301 is to be used, and the input data processing unit 111 outputs bottom data. This weight data 221 may be an example of “second data”.

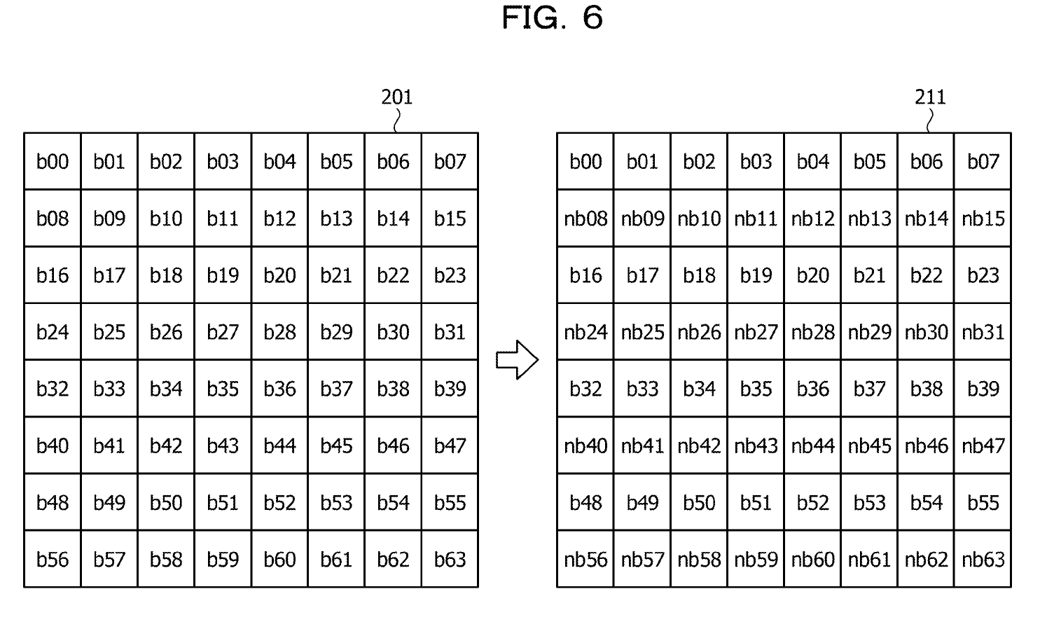

On the other hand, in a case where the bottom data 201 is not compatible with the new filter definition 301, the input data processing unit 111 converts the bottom data 201 to adapt to the new filter definition 301. FIG. 6 illustrates an example of a conversion of bottom data.

The input data processing unit 111 calculates the average of a particular piece of element data and an adjacent piece of element data and stores the calculated average at the location of the particular piece of element data for each of all pieces of element data in every two rows of the bottom data 201. For example, bottom data 201 illustrated in FIG. 6 includes 8×8 pieces of element data b00 to b63. The input data processing unit 111 determines that the conversion is not performed on the first row, but the conversion is to be performed on every two rows starting from the second row.

The input data processing unit 111 calculates the average of element data b08 and element data b09 in the second row. The input data processing unit 111 employs the calculated average as element data nb08 and stores the element data nb08 at a location of the element data b08. Next, the input data processing unit 111 calculates the average of element data b09 and element data b10, and the input data processing unit 111 employs the calculated average as element data nb09 and stores the element data nb09 at a location of the element data b09. The input data processing unit 111 repeats the process of calculating the average value of two adjacent pieces of element data and storing the resultant average value at a location of a smaller element number sequentially for the element data b08 to b15. Note that as for the element data b15, next element data b16 does not exist at a location to the right of the element data b15. Therefore, the average value is calculated assuming that element data with a value of 0 exists to the right of the element data b15. For example, the input data processing unit 111 calculates the average of the element data b15 and the element data whose value is equal to 0, and employs the calculated average as element data nb15 and stores it at the location of the element data b15. In the above-described manner, the converted values of the element data nb08 to nb15 in the second row are determined by the input data processing unit 111.

Similarly, the input data processing unit 111 calculates element data nb24 to nb31, nb40 to nb47, and nb56 to nb63 in the fourth, sixth, and eighth rows. In this manner, the input data processing unit 111 produces bottom data 211 converted from the bottom data 201. Hereinafter, in a case where all pieces of element data of the bottom data 211 are represented, an expression “element data b00 to nb63” is used.

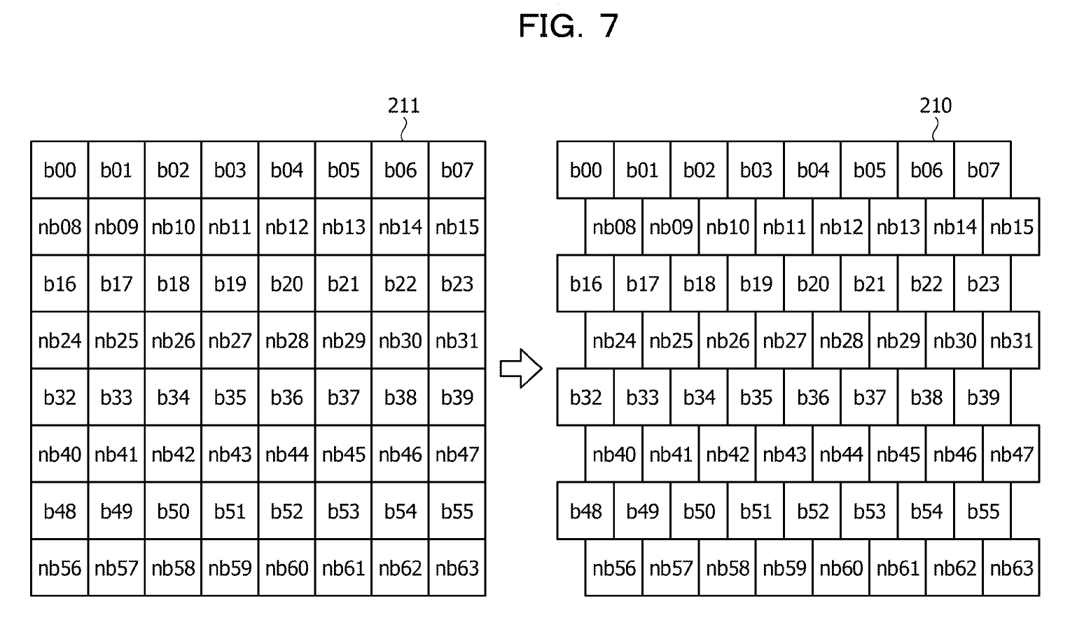

FIG. 7 illustrates an example of bottom data obtained via the conversion. The pieces of element data b00 to nb63 of the bottom data 211 are placed such that the pieces of element data are assigned to respective corresponding dots. For example, the operation processing apparatus 1 performs the forward convolution operation using the converted bottom data 211. Note that when the image is seen with eyes, the appearance of the bottom data 210 is such that the converted element data nb08 to nb15, nb24 to nb31, nb40 to nb47, and nb56 to nb63 in the respective rows are shifted to the right by one-half of dot. That is, the bottom data 210 in FIG. 7 indicates how the bottom data 211 looks like when seen with eyes. In the following description, for ease of a better understanding, the bottom data 210 indicating the actual appearance of the converted bottom data 211 is used.

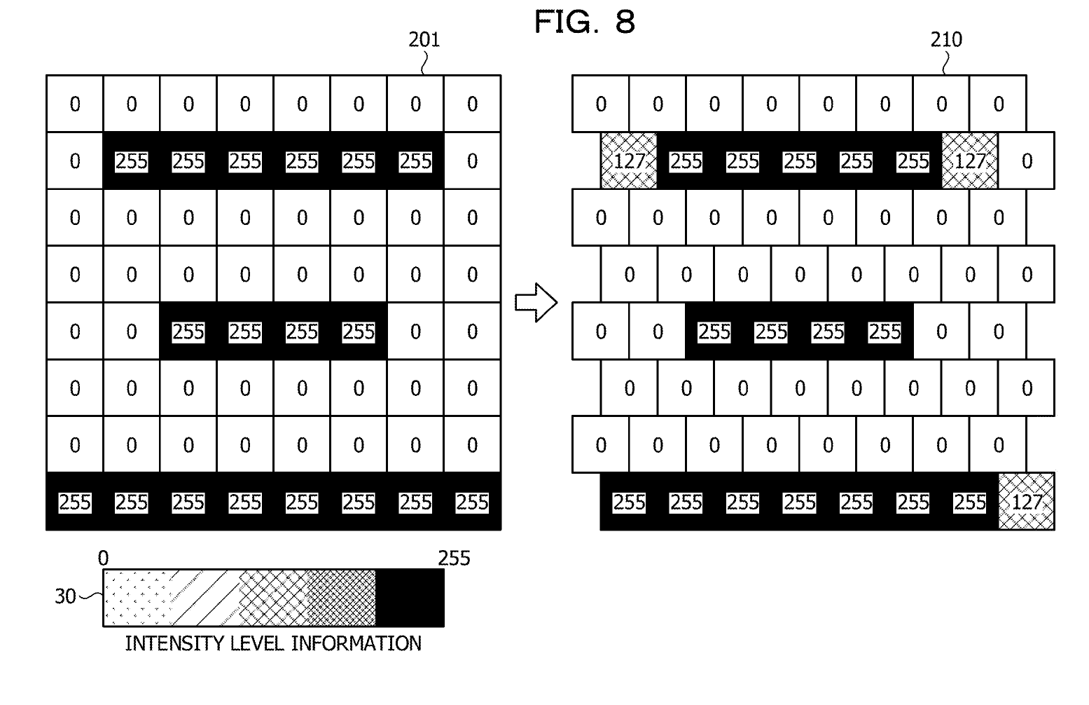

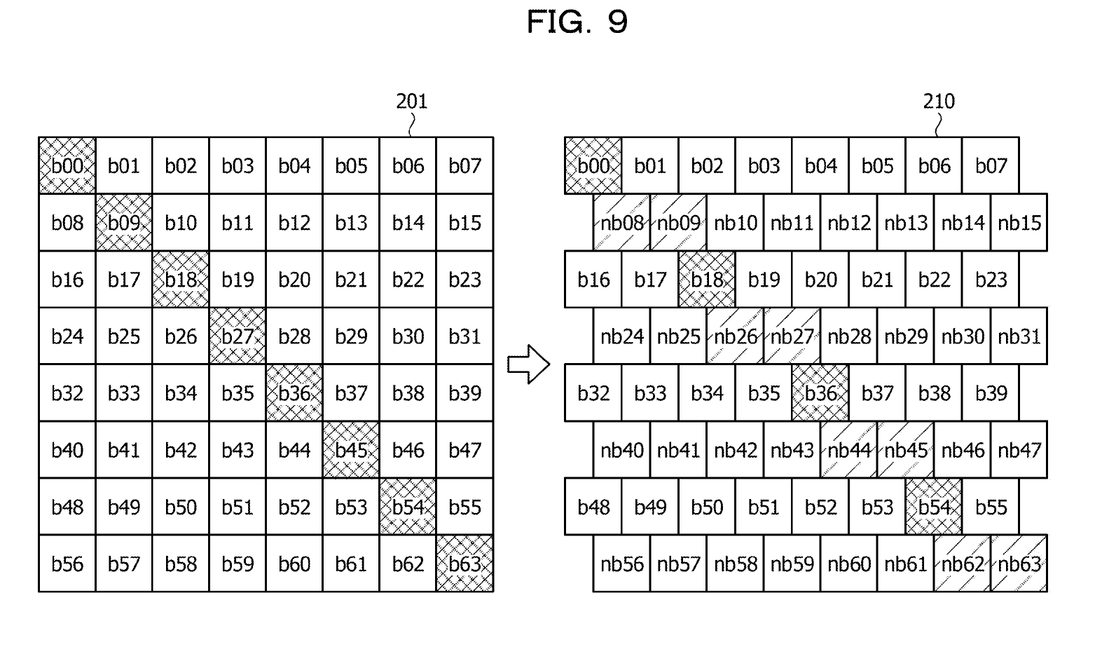

FIG. 8 and FIG. 9 each illustrates an example of a conversion of bottom data.

For example, let it be assumed that bottom data 201 representing a Chinese character indicating three, consisting of three horizontal line segments, that is, a top, middle, and bottom line segments, as illustrated in FIG. 8, is input to the input data processing unit 111. In this case, the top line segment exists in the second row of the bottom data 201, the middle line segment exits in the fifth row, and the bottom line segment exists in the eighth row. Each piece of the element data b00 to b63 has a value represented by intensity level information 30. In the bottom data 201, each piece of element data other than element data indicating the Chinese character described above has a value of 0 indicating a white color. Furthermore, in the bottom data 201, each piece of element data indicating the Chinese character described above has a value of 255 indicating black.

The input data processing unit 111 calculates the average of each two adjacent pieces of element data b08 to b15 in the second row thereby obtaining converted element data nb08 to nb15. In this case, the element data nb08 has a value of 127 and the pieces of element data nb09 to nb13 each have a value of 255. The element data nb14 has a value of 127. The element data nb15 has a value of 0.

Furthermore, the input data processing unit 111 calculates the average of each two adjacent pieces of element data b24 to b31 and b40 to b47 in the fourth and sixth rows thereby obtaining converted element data nb24 to nb31 and nb40 to nb47. In this case, the pieces of element data b24 to b31 and b40 to b47 in the fourth and sixth rows all have a value of 0, and thus the pieces of converted element data nb24 to nb31 and nb40 to nb47 also all have a value of 0.

Furthermore, the input data processing unit 111 calculates the average of each two adjacent pieces of element data b56 to b63 in the eighth row thereby obtaining converted element data nb56 to nb63. In this case, each piece of the element data nb56 to bn62 has a value of 255. The element data nb64 has a value of 127.

The input data processing unit 111 converts the bottom data 201 representing an image of the Chinese character indicating three. In this case, the converted bottom data 210 represents an image of the Chinese character of three in which there is a slight unevenness in intensity level as illustrated in FIG. 8.

Next, an example is described below for a case where bottom data 201 representing an image of a diagonal line such as that illustrated in FIG. 9 is input to the input data processing unit 111. In this case, a line exists along a diagonal of the bottom data 201. Also in this case, each piece of the element data b00 to b63 has a value represented by intensity level information 30 illustrated in FIG. 8. Each piece of element data b00, b09, b18, b27, b36, b45, b54, and b63 representing the diagonal line has a value representing gray, and each of the other pieces of element data has a value of 0.

The input data processing unit 111 calculates the average of each two adjacent pieces of element data b08 to b15, b24 to b31, b40 to b47, and b56 to b63 thereby obtaining element data nb08 to nb15, nb24 to nb31, nb40 to nb47, and nb56 to nb63. In this case, the pieces of element data nb08, nb09, nb26, nb27, nb44, nb45, nb62, and nb63 have values one-half the values of the pieces of element data b08 to b15, b24 to b31, b40 to b47, and b56 to b63. Each piece of the element data nb10 to nb15, nb24 to nb25, nb28 to nb31, nb40 to nb43, nb46 to nb47, and nb56 to nb61 has a value of 0.

In this case, the input data processing unit 111 converts the bottom data 201 representing the image of the diagonal line. In this case, the resultant converted bottom data 210 represents an image of a diagonal line in which there is a slight unevenness in intensity level as illustrated in FIG. 9.

As described above, the bottom data 210 produced via the conversion by the input data processing unit 111 can be used as data regarding as indicating the same image, in the vertical, horizontal, and diagonal directions, as that represented by the unconverted bottom data 201. In most cases, images can be represented by a combination of vertical line segments, horizontal line segments, and diagonal line segments, and thus the bottom data 210 obtained via the conversion can be used to represent substantially the same image as that represented by the unconverted bottom data 201.

The input data processing unit 111 outputs the converted bottom data 210 to the multiplication operation unit 112. Furthermore, the input data processing unit 111 notifies the multiplication operation unit 112 that the weight data 221 is to be used.

In the case of the operation processing layer 11, which is the first layer, illustrated in FIG. 1, the input data processing unit 111 uses the input data 2 input from the outside as the bottom data 201, and thus there is a possibility that the bottom data 201 is not compatible with the new filter definition 301. In this case, the input data processing unit 111 converts the bottom data 201 to adapt to the new filter definition 301. In contrast, in the operation processing layers 12 to 13, which are the second and following layers, illustrated in FIG. 1, the top data 209 output from the preceding operation processing layer 10 is already compatible with the new filter definition 301, and thus the input data processing unit 111 is allowed to directly output the bottom data 201 to the multiplication operation unit 112 without performing the conversion. This input data processing unit 111 is an example of the “conversion unit”.

In a case where the new filter definition 301 is not to be used, the multiplication operation unit 112 receives, from the input data processing unit 111, the notification that the weight data 202 produced using the filter definition 302 is to be used. Furthermore, the multiplication operation unit 112 receives an input of the non-converted bottom data 201.

The multiplication operation unit 112 performs multiplication operation of each piece of element data in the normal forward convolution operation using the weight data 202 produced using the filter definition 302 and the bottom data 201. The multiplication operation unit 112 then outputs a result of the multiplication operation to the addition operation unit 113.

On the other hand, in the case where the new filter definition 301 is used, the multiplication operation unit 112 receives, from the input data processing unit 111, the notification that the weight data 221 is to be used. The multiplication operation unit 112 receives an input of the bottom data 201 compatible with the new filter definition 301 or the bottom data 210 converted so as to be compatible with the new filter definition 301. The multiplication operation unit 112 performs the multiplication operation of each piece of element data in the forward convolution operation using the input bottom data 201 or 210 and the weight data 221.

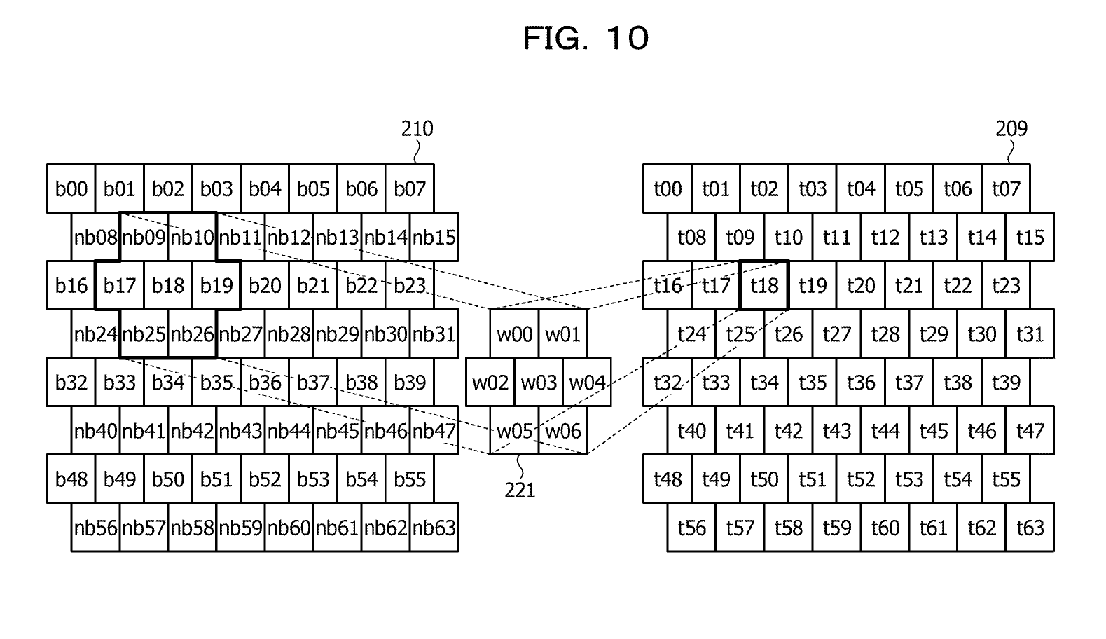

Referring to FIG. 10, an example of a multiplication operation method is described below for a case where the bottom data 210 obtained via the conversion is used. FIG. 10 illustrates an example of a forward convolution operation for a case in which a new filter definition is used. In this example, it is assumed by way of example that the number of strides is one, that is, the weight data 221 is shifted by one stride at a time. Hereinafter, a direction, the vertical direction in this specific example, in which columns of the bottom data 210 in FIG. 10 extend will be referred to as a “column direction”, and a direction, the horizontal direction in this example, in which rows extend will be referred to as a “row direction”.

The multiplication operation unit 112 receives an input of the bottom data 210 illustrated in FIG. 10. The multiplication operation unit 112 acquires the weight data 221 illustrated in FIG. 10 from the weight data storage unit 115. The multiplication operation unit 112 places the weight data 221 such that the first column of the weight data 221 is overlaid on the first column of the bottom data 210 and the respective pieces of element data of the weight data 221 are overlaid on pieces of element data with smallest allowable element numbers of the bottom data 210. For example, in the example illustrated in FIG. 10, the multiplication operation unit 112 arranges the weight data 221 such that element data w00 is overlaid on the element data b01, element data w02 is overlaid on the element data nb09, and element data w05 is overlaid on the element data b17. The multiplication operation unit 112 calculates the products of the pieces of element data of the bottom data 210 and the respective corresponding overlaid pieces of weight data 221, and outputs the resultant products to the addition operation unit 113. Hereinafter, the process of placing the weight data 221 at a particular location on the bottom data 210 and calculating the products of the pieces of element data of the bottom data 210 and the respective corresponding overlaid pieces of weight data 221 will be referred to as the “multiplication operation for one piece of element data of the top data 209”.

Next, the multiplication operation unit 112 shifts the position of the weight data 221 on the bottom data 210 in the row direction by one stride, that is, by an amount corresponding to one piece of element data. At the shifted position, the multiplication operation unit 112 performs the multiplication operation for one piece of element data of the top data 209, and outputs the resultant products to the addition operation unit 113. As described above, the multiplication operation unit 112 iteratively performs the process of performing the multiplication for one piece of element data of the top data 209 and thereafter shifting the weight data 221 by one stride in the row direction. If the weight data 221 reaches the end of the row, then, in the following calculation iteration, the multiplication operation unit 112 shifts the position of the weight data 221 in the column direction by one stride, that is, by an amount corresponding to one piece of element data, and the multiplication operation unit 112 returns the position of the weight data 221 to the top position in the row direction. The multiplication operation unit 112 again iteratively performs the process of performing multiplication for one piece of element data of the top data 209 and thereafter shifting the weight data 221 by one stride in the row direction. The multiplication operation unit 112 repeats the multiplication for one piece of element data of the top data 209 until the bottom row of the weight data 221 reaches the bottom row of the bottom data 210 and the weight data 221 reaches the end of the bottom data 210.

An example is described below for a case where the weight data 221 is placed on the bottom data 210 such that the edge of the weight data 221 is overlaid on the edge, denoted by a thick line frame, of the bottom data 210 in FIG. 10. Herein the multiplication between pieces of element data is denoted by a multiplication symbol. The multiplication operation unit 112 calculates products for one piece of top data 209 as w00×nb09, w01×nb10, w02×b17, w03×b18, w04×b19, w05×nb25, and w06×nb26. The multiplication operation unit 112 then outputs the resultant products to the addition operation unit 113.

The addition operation unit 113 receives an input of the multiplication operation result from the multiplication operation unit 112. The addition operation unit 113 adds together the received products for one piece of element data of the top data 209 thereby calculating the sum of the products. Hereinafter, the addition operation of calculating the sum of the products for one piece of top data 209 will be referred to as “addition operation for one piece of element data of the top data 209.”. The addition operation unit 113 outputs a resultant sum to the output data production unit 114. The addition operation unit 113 repeatedly performs the addition operation for one piece of element data of the top data 209 for the all products calculated by multiplication operation unit 112 in the corresponding multiplication operation for one piece of element data of the top data 209, and the addition operation unit 113 outputs the resultant sum to the output data production unit 114.

An example is described below for a case where the weight data 221 is placed on the bottom data 210 in the area surrounded by the thick line frame in FIG. 10. The addition operation unit 113 receives, from the multiplication operation unit 112, inputs of w00×nb09, w01×nb10, w02×b17, w03×b18, w04×b19, w05×nb25, and w06×nb26. The addition operation unit 113 then calculates the sum as w00×nb09+w01×nb10+w02×b17+w03×b18+w04×b19+w05×nb25+w06×nb26.

The output data production unit 114 receives, from the addition operation unit 113, an input of the sum obtained as a result of the addition operation for one piece of element data of the top data 209. The output data production unit 114 repeatedly performs a process of assigning acquired sums to corresponding one piece of element data of the top data 209 sequentially from one piece of element data to another starting with the one piece of element data at the location of beginning position of the top data 209. For example, in the case where the weight data 221 is placed on the bottom data 210 at the location surrounded by the thick line frame in FIG. 10, the output data production unit 114 assigns the acquired sum to the element data t18. That is, w00×nb09+w01×nb10+w02×n17+w03×n18+w04×n19+w05×nb25+w06×nb26 is assigned to the element data t18 of the top data 209. The output data production unit 114 repeatedly performs the process of assigning the acquired sum to a corresponding one piece of element data of the top data 209 one by one thereby producing the top data 209. The output data production unit 114 then outputs the generated top data 209 to the activation process unit 102. Hereinafter, the multiplication operation and the addition operation for one piece of element data of the top data 209 and the assignment of the resultant addition operation result to one piece of element data of the top data 209 will be referred to collectively as the “multiply-accumulate operation for one piece of element data of the top data 209”. The multiplication operation unit 112, the addition operation unit 113, and the output data production unit 114 may be an example of the “convolution operation unit”.

For example, in the case where the filter definition 302 is used, in the multiply-accumulate operation for one piece of element data of the top data 209, the convolution operation unit 101 performs the multiplication operation nine times and performs the addition operation to calculate the sum of the resultant nine multiplication operation results. In contrast, in the case where the new filter definition 301 is used, in the multiply-accumulate operation for one piece of element data of the top data 209, the convolution operation unit 101 performs the multiplication operation seven times and performs the addition operation to calculate the sum of seven multiplication operation results. Thus, when the new filter definition 301 is used, the number of multiplication operations and the number of values added together in the addition operation are both smaller than when the filter definition 302 is used. For example, in the forward convolution operation, in the case where the new filter definition 301 is used, a smaller storage area is used in the operation than in the case where the filter definition 302, and thus an increase in calculation efficiency is achieved.

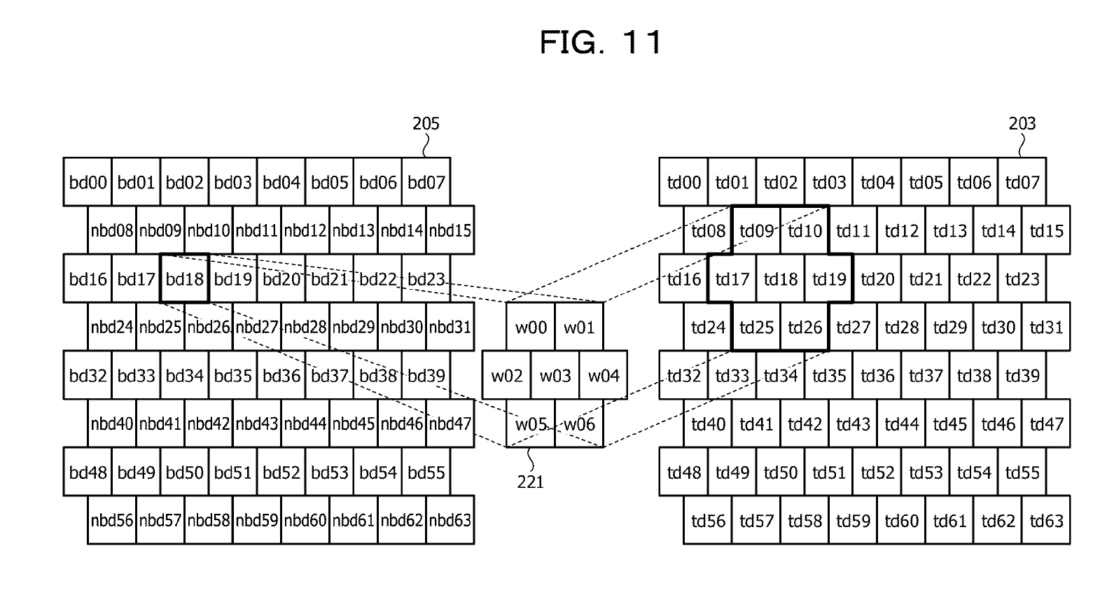

The convolution operation unit 106 illustrated in FIG. 3 performs a backward convolution operation on the data obtained via the inverse normalization process performed by the activation process unit 105. The convolution operation unit 106 performs the backward convolution operation. FIG. 11 illustrates an example of a backward-convolution bottom-difference operation for a case where the new filter definition is used.

In this example, the forward convolution operation is performed using the bottom data 210 obtained via the conversion from the 8×8 bottom data 201 used in FIG. 10 and the weight data 221. In this case, the convolution operation unit 106 receives, from the activation process unit 105, an input of the top difference data 203 having the same arrangement form as that of the top data 209 determined via the forward convolution operation as illustrated in FIG. 10, that is, having the arrangement form in which positions of every two rows are shifted. The top difference data 203 also has the same arrangement form as that of the top data 209. The bottom difference data 205 calculated via the backward-convolution bottom-difference operation has the same arrangement form as that of the bottom data 201. The top difference data 203 includes element data td00 to td63. The bottom difference data 205 includes element data bd00 to nbd63.

The convolution operation unit 106 receives an input of the top difference data 203 illustrated in FIG. 11. The convolution operation unit 106 places the weight data 221 on the top difference data 203 such that the first column of the weight data 221 is overlaid on the first column of the top difference data 203 and the respective pieces of element data of the weight data 221 are overlaid on pieces of element data with smallest allowable element numbers of the top difference data 203. For example, in the case illustrated in FIG. 11, the convolution operation unit 106 places the weight data 221 such that the element data w00 is overlaid on the element data td01, the element data w02 is overlaid on the element data td09, and the element data w05 is overlaid on the element data td17. The convolution operation unit 106 then multiplies the respective pieces of element data of the top difference data 203 by corresponding overlying pieces of element data of the weight data 221. Furthermore, the convolution operation unit 106 adds together all resultant products thereby obtaining the sum of the products. The convolution operation unit 106 employs the calculated sum as the element data bd00 of the bottom difference data 205.

The convolution operation unit 106 shifts the position of the weight data 221 on the top difference data 203 in the row direction by an amount corresponding to the number of strides, that is, by an amount corresponding to one piece of element data. At the resultant shifted position, the convolution operation unit 106 performs the multiplication operation for one piece of the bottom difference data 205 and adds together the resultant products thereby obtaining the sum of the products. The convolution operation unit 106 iteratively performs the above-described calculation of the products and the sum while shifting the position of the weight data 221 in the row direction by the amount corresponding to the number of strides at the end of each iteration of calculation. When the position of the weight data 221 reaches the end in the row direction, the convolution operation unit 106 shifts the position of the weight data 221 in the column direction by an amount corresponding to the number of strides, that is, by an amount corresponding to one piece of element data, and, furthermore, the convolution operation unit 106 returns the weight data 221 to the top position in the row direction. The convolution operation unit 106 iteratively performs the process of performing the multiplication operation and the addition operation while shifting the position of the weight data 221 in the row direction. The convolution operation unit 106 repeats this process of performing the multiplication operation and the addition operation until the bottom row of the weight data 221 reaches the bottom row of the top difference data 203, and the weight data 221 reaches the end of the top difference data 203. The convolution operation unit 106 assigns the results of the respective iterations of calculation of the multiplication operation and the addition operation sequentially to the pieces of element data b01 to nb63 of the bottom difference data 205 in the order of element number. Hereinafter, the total operation including the calculation of the multiplication operation and the addition operation in the state in which the weight data 221 is overlaid at a particular position on the top difference data 203 and the assignment of the calculation result to one of the pieces of element data b00 to nb63 of the bottom difference data will be referred to as the “multiply-accumulate operation for one piece of element data of the bottom difference data 205”.

An example is described below for a case where the weight data 221 is placed on the top difference data 203 such that the edge of the weight data 221 is overlaid on the edge, denoted by a thick line frame, of the top difference data 203 illustrated in FIG. 11. Herein the multiplication between pieces of element data is denoted by a multiplication symbol. In the multiply-accumulate operation for one piece of element data of the bottom difference data 205, the convolution operation unit 106 calculates w00×td09+w01×td10+w02×td17+w03×td18+w04×td19+w05×td25+w06×td26, and employs a calculation result as element data bd18.

For example, in the case where the filter definition 302 is used, in the multiply-accumulate operation for one piece of element data of the bottom difference data 205, the convolution operation unit 101 performs the multiplication operation nine times and performs the addition operation to calculate the sum of nine multiplication operation result. In contrast, in the case where the new filter definition 301 is used, in the multiply-accumulate operation for one piece of element data of the bottom difference data 205, the convolution operation unit 101 performs the multiplication operation seven times and performs the addition operation to calculate the sum of seven multiplication operation results. Therefore, when the new filter definition 301 is used, the number of multiplication operations and the number of values added together in the addition operation are both smaller than when the filter definition 302 is used. Also in the case of the backward-convolution bottom-difference operation, in the case where the new filter definition 301 is used, a smaller storage area is used in the operation than in the case where the filter definition 302, and thus an increase in calculation efficiency is achieved.

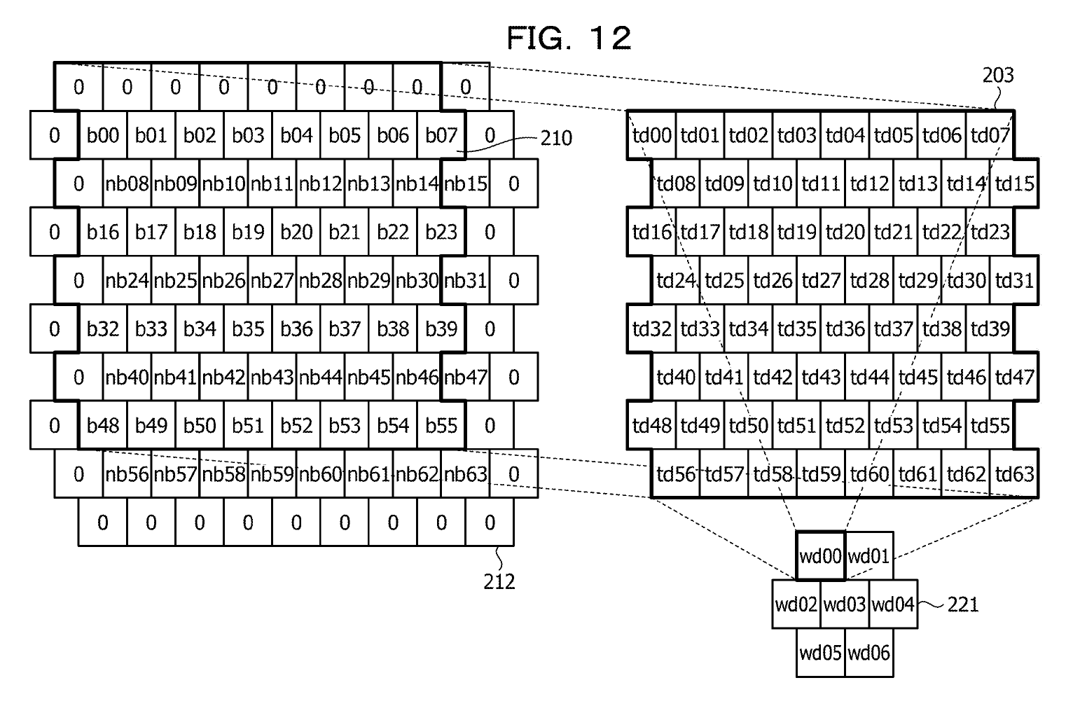

FIG. 12 illustrates an example of a backward-convolution weight-difference operation using a new filter definition. The weight difference data 204 calculated via the backward-convolution weight-difference operation has the same arrangement form as that of the weight data 221. The weight difference data 204 includes pieces of element data wd00 to wd07.

The convolution operation unit 106 acquires the bottom data 210 used in the forward convolution operation. Furthermore, the convolution operation unit 106 receives an input of the top difference data 203 illustrated in FIG. 12. The convolution operation unit 106 determines whether the bottom data 210 has a proper size used in calculating the weight difference data 204. In a case where the size is small, the convolution operation unit 106 adds element data 212 with a value of 0 around the bottom data 210. Hereinafter, the bottom data 210 added with the element data 212 will be referred to simply as bottom data 210.

The convolution operation unit 106 places the top difference data 203 such that the first column of the top difference data 203 is overlaid on the first column of the bottom data 210 and the respective pieces of element data of the top difference data 203 are overlaid on pieces of element data with smallest allowable element numbers of the bottom data 210. For example, the convolution operation unit 106 places the top difference data 203 such that the edge of the top difference data 203 is overlaid on the edge, denoted by a thick line frame, of the bottom data 210. The convolution operation unit 106 multiplies the respective pieces of element data of the bottom data 210 by corresponding overlying pieces of element data of the top difference data 203. The convolution operation unit 106 adds together all resultant products thereby obtaining the sum of the products. The convolution operation unit 106 then employs the calculated sum as the element data w00 of the weight difference data 204.

The convolution operation unit 106 shifts the position of the top difference data 203 on the bottom data 210 in the row direction by an amount corresponding to the number of strides, that is, by an amount corresponding to one piece of element data. At the resultant shifted position, the convolution operation unit 106 performs the multiplication operations of the respective pieces of element data of the bottom data 210 and corresponding overlying pieces of element data of the top difference data 203, and adds together the resultant products thereby obtaining the sum of the products. The convolution operation unit 106 iteratively performs the above-described calculation of the products and the sum while shifting the position of the top difference data 203 in the row direction by the amount corresponding to the number of strides at the end of each calculation iteration. When the position of the top difference data 203 reaches the end in the row direction, then in the next calculation iteration, the convolution operation unit 106 shifts the position of the top difference data 203 in the column direction by an amount corresponding to the number of strides, that is, by an amount corresponding to one piece of element data, and, furthermore, the convolution operation unit 106 returns the top difference data 203 to the top position in the row direction. The convolution operation unit 106 repeats the multiplication operation and the addition operation while shifting the position of the top difference data 203 in the row direction. The convolution operation unit 106 repeats this process of performing the multiplication operation and the addition operation until the bottom row of the top difference data 203 reaches the bottom row of the bottom data 210, and the top difference data 203 reaches the end of the bottom data 210. The convolution operation unit 106 assigns the results of the respective iterations of the multiplication operation and the addition operation sequentially to the pieces of element data w01 to w07 of the weight difference data 204 in the order of element number. Hereinafter, the total operation including the process of calculating the multiplication operation and the addition operation in the state in which the top difference data 203 is overlaid at a particular position on the bottom data 210 and the assignment of the calculation result to one of the pieces of element data w00 to w07 of the weight difference data 204 will be referred to as the “multiply-accumulate operation for one piece of element data of the weight difference data 204”.

An example is described below for a case where the top difference data 203 is placed on the bottom data 210 such that the top difference data 203 is located in an area surrounded by a thick line frame illustrated in FIG. 12. Herein the multiplication between pieces of element data is denoted by a multiplication symbol. In the multiply-accumulate operation for one piece of element data of the weight difference data 204, the convolution operation unit 106 calculates td00×0+ . . . +td07×0+td08×b00+ . . . +td15×b07+td16×0+td17×nb08+ . . . +td23×nb14+ . . . +td56×b48+ . . . td63×b55, and the convolution operation unit 106 employs the result of the calculation as the element data wd00.

in the case where the filter definition 302 is used, the convolution operation unit 101 performs the multiply-accumulate operation for one piece of element data of the weight difference data 204 nine times. In contrast, in the case where the new filter definition 301 is used, the convolution operation unit 101 performs the multiply-accumulate operation for one piece of element data of the weight difference data 204 only seven times. That is, use of the new filter definition 301 makes it possible to reduce the number of calculations compared with the number of calculations performed when the conventional filter definition 302 is used. Also in the case of the backward-convolution weight-difference operation, when the new filter definition 301 is used, a smaller storage area is used in the operation than when the conventional filter definition 302, and thus an increase in calculation efficiency is achieved.

The activation process unit 102 illustrated in FIG. 3 normalizes the top data output from the convolution operation unit 101. The pooling process unit 103 performs element data decimation or aggregation on the top data normalized by the activation process unit 102 to make the response insensible to a small positional change. The process performed by the pooling process unit 103 is referred to as a pooling process. After the pooling process unit 103 performs the pooling process on the top data, the pooling process unit 103 outputs the resultant top data to a following operation processing layer 10. The pooling process unit 103 outputs a tag 151 indicating the process performed on the data to the pooling process unit 104.

The pooling process unit 104 receives, from the pooling process unit 103, an input of the tag 151 indicating the pooling process performed on the data. The pooling process unit 104 also receives an input of the bottom difference data from a following operation processing layer 10. The pooling process unit 104 performs, on the acquired bottom difference data, a process inverse to the pooling process identified by the acquired tag 151. This process performed by the pooling process unit 104 is referred to as an “inverse pooling process”. The activation process unit 105 performs the activation process on the data having been subjected to the inverse pooling process by the pooling process unit 104.

The learning operation performed by the operation processing apparatus 1 has been described above. The operation processing apparatus 1 performs a recognition operation on the input data 2 using the weight data 202 obtained via the learning. Thus, a recognition process performed by each operation processing layer 10 is described below.

The convolution operation unit 101 receives an input of bottom data and performs a forward convolution operation using weight data acquired via the learning. The activation process unit 102 and the pooling process unit 103 each performs a pooling process such as normalization on the top data. Thereafter, the pooling process unit 103 outputs the top data having been subjected to the process to a following operation processing layer 10. The operation processing apparatus 1 repeats the forward convolution operation described above from one operation processing layer 10 to the next until the output data 3 for recognition is finally acquired.

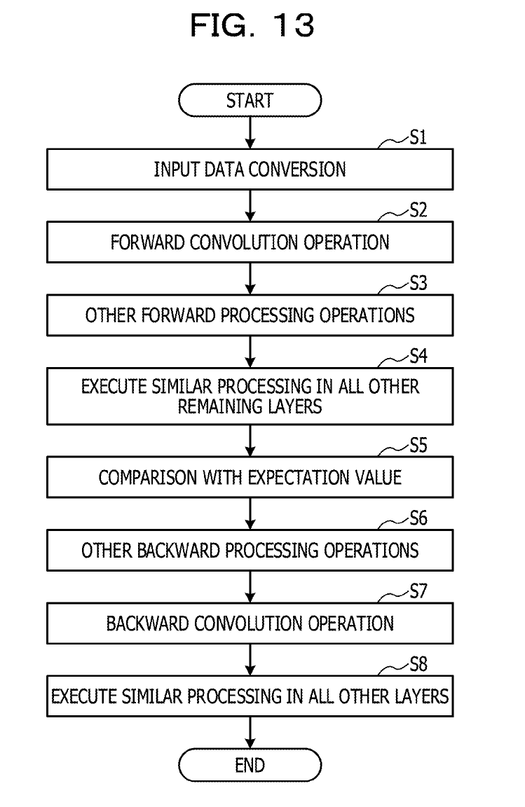

Referring to FIG. 13, a flow of a process performed in an operation processing layer is described below for a case where the new filter definition 301 is used. FIG. 13 illustrates an example of a process in an operation processing layer for a case where a new filter definition is used.

The input data processing unit 111 in the first-layer operation processing layer 11 calculates the average of each two adjacent pieces of element data in every other row of the input data 2, and employs the result as one of two pieces of element data thereby producing the bottom data 210 compatible with the new filter definition 301 (operation S1). The input data processing unit 111 then outputs the bottom data 210 to the multiplication operation unit 112.

The multiplication operation unit 112 receives an input of the bottom data 210 from the input data processing unit 111. The multiplication operation unit 112, the addition operation unit 113, and the output data production unit 114 repeatedly performs the multiply-accumulate operation for one piece of element data of the top data 209 (operation S2). The output data production unit 114 outputs an operation result as top data 209.

The activation process unit 102 and the pooling process unit 103 perform the other forward processing operations including the pooling process for normalization on the top data 209 output from the output data production unit 114 (operation S3). The pooling process unit 103 outputs resultant data subjected to the process to the second-layer operation processing layer 12.

The second to (n−1)th-layer operation processing layers 10 and the nth-layer operation processing layer 13 perform similar processes including the forward convolution operation and the other forward processing operations (operation S4).

The nth-layer operation processing layer 13 compares the output data 3 with the expectation value 207 (operation S5).

The pooling process unit 104 and the activation process unit 105 in the nth-layer operation processing layer 13 perform the other backward processing operations including the inverse pooling process on the comparison result (operation S6). The activation process unit 105 outputs the resultant data having been subjected to the process as the top difference data 203 to the convolution operation unit 106.

The convolution operation unit 106 of the nth-layer operation processing layer 13 receives an input of the top difference data 203 from the activation process unit 105. The convolution operation unit 106 performs the backward convolution operation using the top difference data 203, the weight data 202, and the bottom data 210 (operation S7). The convolution operation unit 106 updates the weight data 202. The convolution operation unit 106 outputs the determined bottom difference data 205 to the (n−1)th-layer operation processing layer 10.

The (n−1)th to third-layer operation processing layer 10, the second-layer operation processing layer 12, and the first-layer operation processing layer 11 perform the process including the other backward processing operations and the backward convolution operation in a similar manner as described above (operation S8). As a result, the weight data 202 in the (n−1)th to third-layer operation processing layers 10, the second-layer operation processing layer 12, and the first-layer operation processing layer 11 is updated.

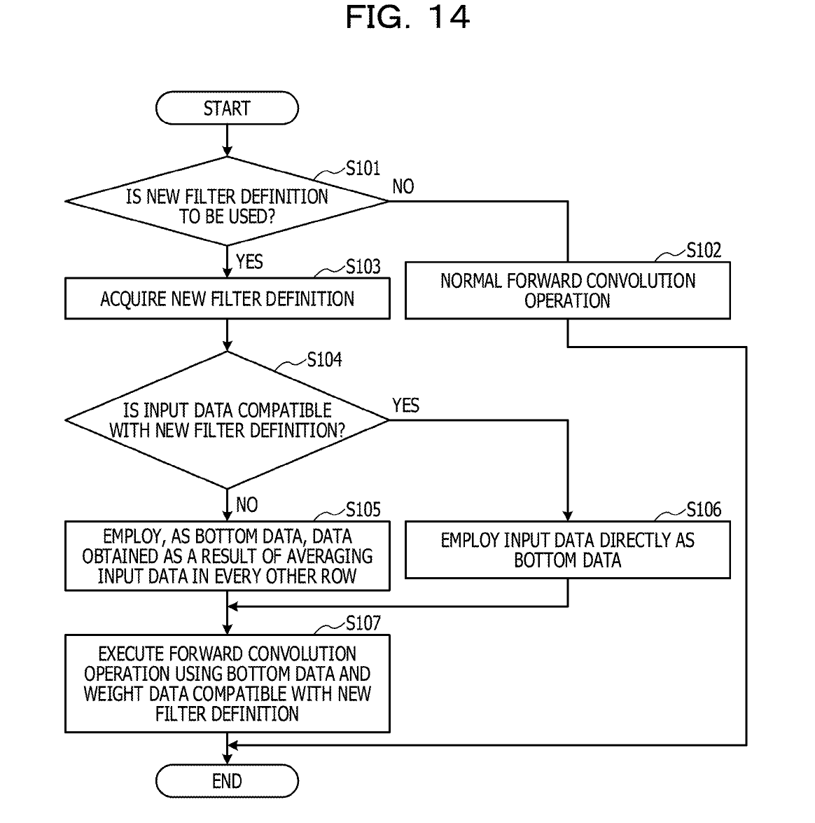

Referring to FIG. 14, a flow of a process performed in the convolution operation unit 101 is described below. FIG. 14 illustrates an example of a forward convolution operation by the convolution operation unit 101.

The input data processing unit 111 determines whether the new filter definition 301 is to be used (operation S101). In a case where the new filter definition 301 is not to be used, (No in operation S101), the input data processing unit 111 directly outputs the input data as the bottom data 201 to the multiplication operation unit 112. The multiplication operation unit 112, the addition operation unit 113, and the output data production unit 114 execute a normal forward convolution operation (operation S102) and completes the forward convolution operation.

In contrast, in the case where the new filter definition 301 is to be used (Yes in operation S101), the input data processing unit 111 acquires the weight data 221 compatible with the new filter definition 301 from the weight data storage unit 115 (operation S103).

Next, the input data processing unit 111 determines whether the input data is compatible with the new filter definition 301 (operation S104). In a case where the input data is not compatible with the new filter definition 301 (No in operation S104), the input data processing unit 111 employs, as the bottom data 201 to be used in the operation, data acquired by averaging input data given as a result of the process by the preceding layer for every other row (operation S105).

In a case where the input data is compatible with the new filter definition 301 (Yes in operation S104), the input data processing unit 111 employs the input data given by the result of the process in the preceding layer directly as the bottom data 201 to be used in the operation (operation S106).

The input data processing unit 111 outputs the bottom data 201 compatible with the new filter definition 301 to the multiplication operation unit 112. The multiplication operation unit 112, the addition operation unit 113, and the output data production unit 114 execute the forward convolution operation using the input bottom data 201 and the weight data 221 compatible with the new filter definition 301 (operation S107).

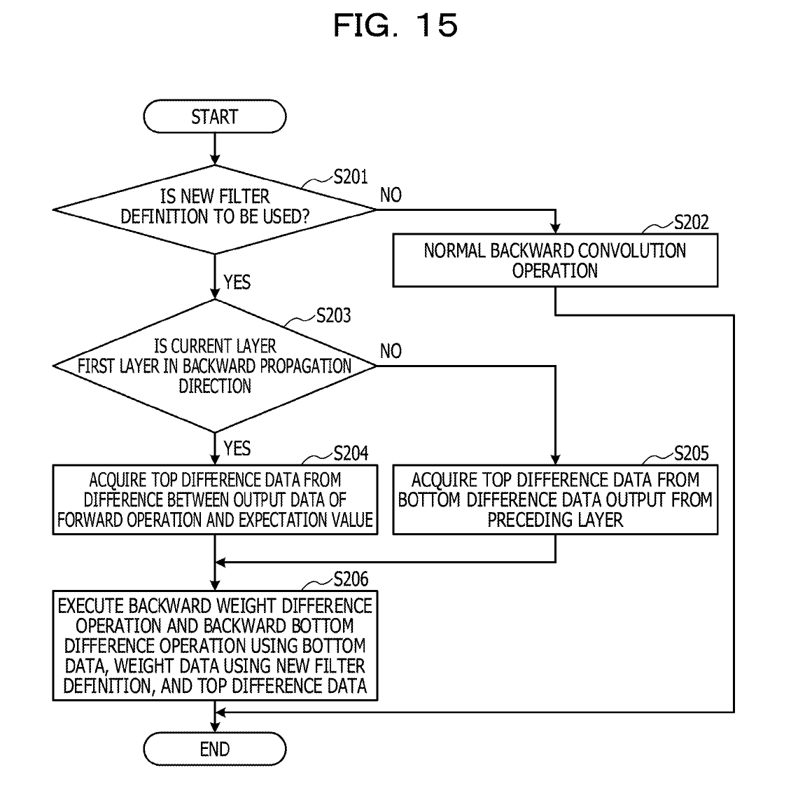

Next, referring to FIG. 15, a flow of the backward convolution operation performed by the convolution operation unit 106 is described below. FIG. 15 illustrates an example of a backward convolution operation performed by the convolution operation unit 106.

The convolution operation unit 106 determines whether the new filter definition 301 is to be used (operation S201). In a case where the new filter definition 301 is not to be used (No in operation S201), the convolution operation unit 106 executes a normal backward convolution operation directly using the input data as the bottom data 201 (operation S202), and completes the forward convolution operation.

On the other hand, in a case where the new filter definition 301 is to be used (Yes in operation S201), the convolution operation unit 106 determines whether the current layer is the first layer in the backward propagation direction (operation S203). In a case where the current layer is the first layer in the backward propagation direction (Yes in operation S203), the convolution operation unit 106 acquires data obtained as a result of the other backward processing operations performed on the difference of the output data 3 in the forward operation from the expectation value 207, and the convolution operation unit 106 employs the acquired data as the top difference data 203 (operation S204).

On the other hand, in a case where the current layer is a layer other than the first layer in the backward propagation direction, (No in operation S203), the convolution operation unit 106 acquires, as the top difference data 203, data obtained as a result of the other backward processing operations performed on the bottom difference data 205 output from the preceding layer (operation S205).

The convolution operation unit 106 performs the backward weight-difference operation and the backward bottom-difference operation using the bottom data 201, the weight data 221 using the new filter definition 301, and the top difference data 203 (operation S206).

As described above, the operation processing apparatus performs the forward convolution operation and the backward convolution operation using the new filter definition includes a smaller number of pieces of element data than the thumber of pieces of element data included in a square matrix filter definition. A table described below indicates the ratio of the amount of operation of a new filter definition to the amount of operation of a conventional filter definition for each of various filter sizes. Here each filter definition is a definition in which the number of pieces of element data per row is reduced by one piece when the row position is shifted by one row from an adjacent row in a direction apart from the central row, and the position of the center point of each row as seen in the row direction is shifted to a point at which the center of the row is located before the number of pieces of element data is reduced.

TABLE 1

amount of operation ratio,
usage data ratio

| | conventional | new filter |
|---|---|---|
| filter size | filter definition | definition |
| 3 × 3 | 1.00 | 0.78 |
| 5 × 5 | 1.00 | 0.76 |
| 7 × 7 | 1.00 | 0.76 |
| 9 × 9 | 1.00 | 0.75 |
| . . . | . . . | . . . |

The operation processing apparatus described above has a feature that allows a reduction in amount of operation in the forward convolution operation and the backward convolution operation. The operation processing apparatus performs operations to convert the input data. However, the increase in the number of operations caused by performing the conversion of the input data is smaller than the reduction, achieved by the input data conversion, in terms of the number of operations in the convolution operation, and thus it is possible to achieve a reduction in the total number of operations. The reduction in the amount of data treated by the operation processing apparatus also contributes to a reduction in a memory throughput and a reduction in a memory size. Even in a case where a filter used does not satisfy a condition for using a speed-up method by a fast Fourier transform, the operation processing apparatus according to the present embodiment allows a reduction in the number of operations in the forward convolution operation and the backward convolution operation. Therefore, the operation processing apparatus is capable of increasing the computation efficiency in the deep learning operation while suppressing the storage capacity used in the operation.

In particular, filters with a 3×3 size are widely used in deep learning, and a reduction in the number of operations is achieved also in the case where a filter with a 3×3 size is used, as described above with reference to the embodiments.

In the operation processing apparatus, it is allowed to reduce the size of the weight data and thus it is allowed to reduce the amount of data in the forward convolution operation and the backward convolution operation.

In a case where the bottom data is converted so as to adapt to the new filter definition, the operation processing apparatus performs the pooling process in which the data calculated in the bottom data is directly used. The operation processing apparatus that performs the pooling process may also be configured as illustrated in FIG. 1 and FIG. 2. In the following description, a description of functions of elements similar to those of the operation processing apparatus described above may be omitted.

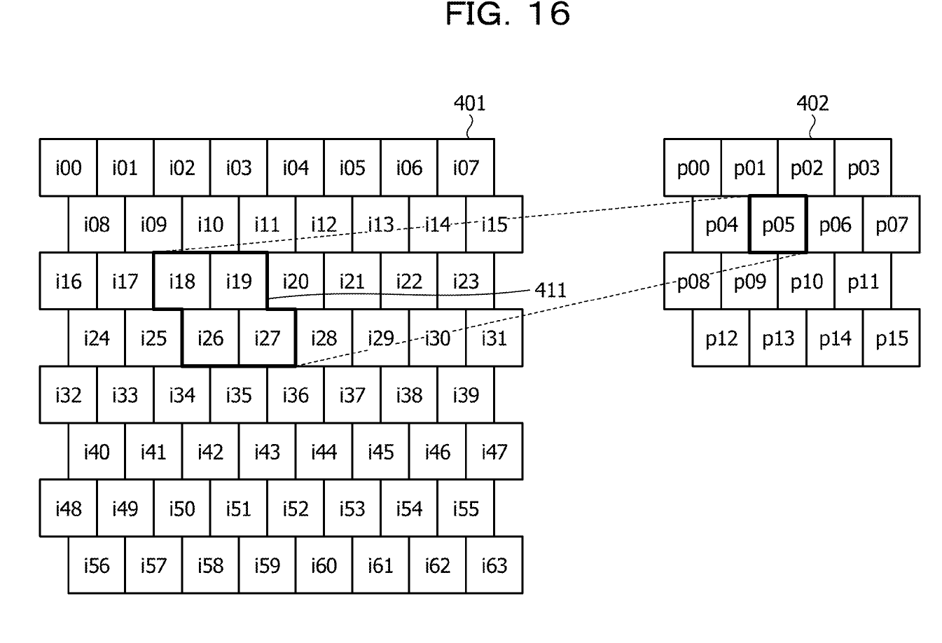

FIG. 16 illustrates an example of a pooling process by a pooling process unit for a case where the number of strides is two.

The pooling process unit 103 receives an input of data produced by performing the normalization, by the activation process unit 102, on the top data 209 output from the convolution operation unit 101. Here it is assumed by way of example that the forward convolution operation is performed using 8×8 bottom data 201 and a new filter definition 301. For example, the pooling process unit 103 receives an input of data 401 illustrated in FIG. 16. In this example, the data 401 includes element data i00 to i63. The element data i00 to i63 respectively correspond to the element data t00 to t63 of the top data 209.

The pooling process unit 103 stores a pooling size defined by a thick line frame 411 on the data 401 in FIG. 16. First, the pooling process unit 103 places the thick line frame 411 such that a top row of the thick line frame 411 is overlaid on the first row of the data 401 and such that the thick line frame 411 is located on pieces of element data having smallest element data numbers. The pooling process unit 103 then acquires element data 100, i01, i08, and i09 of the data 401 overlaid by the thick line frame 411, and performs the pooling process to acquire the average of the acquired pieces of element data or a maximum value thereof. The pooling process unit 103 employs the acquired value as element data p00 of the data 402 to be output.

The pooling process unit 103 iteratively performs the pooling process to acquire the value while shifting the thick line frame 411 in the row direction by an amount corresponding to two pieces of element data. When the thick line frame 411 reaches the end of the row of the data 410, the pooling process unit 103 shifts the thick line frame 411 in the column direction by an amount corresponding to two pieces of element data and returns the horizontal position of thick line frame 411 to the top of the row. The pooling process unit 103 repeats the process of performing the pooling process and acquiring the value while shifting the thick line frame 411 in the row direction by an amount corresponding to two pieces of element data until the bottom row of the thick line frame 411 reaches the end of the bottom row of the data 401. The pooling process unit 103 assigns the acquired values to the respective pieces of element data p01 to p15 of the data 402 to be output.

For example, when the thick line frame 411 is placed at a position on the data 401 as illustrated in FIG. 16, the pooling process unit 103 acquires pieces of element data i18, i19, i26, and i27. The pooling process unit 103 then acquires a value by performing the pooling process using the pieces of element data i18, i19, i26, and i27. The pooling process unit 103 employs the acquired value as the element data p05 of the data 402.

The pooling process unit 103 acquires element data p00 to p15 thereby obtaining complete data 402. Thereafter, the pooling process unit 103 outputs the data 402 to a following operation processing layer 10.

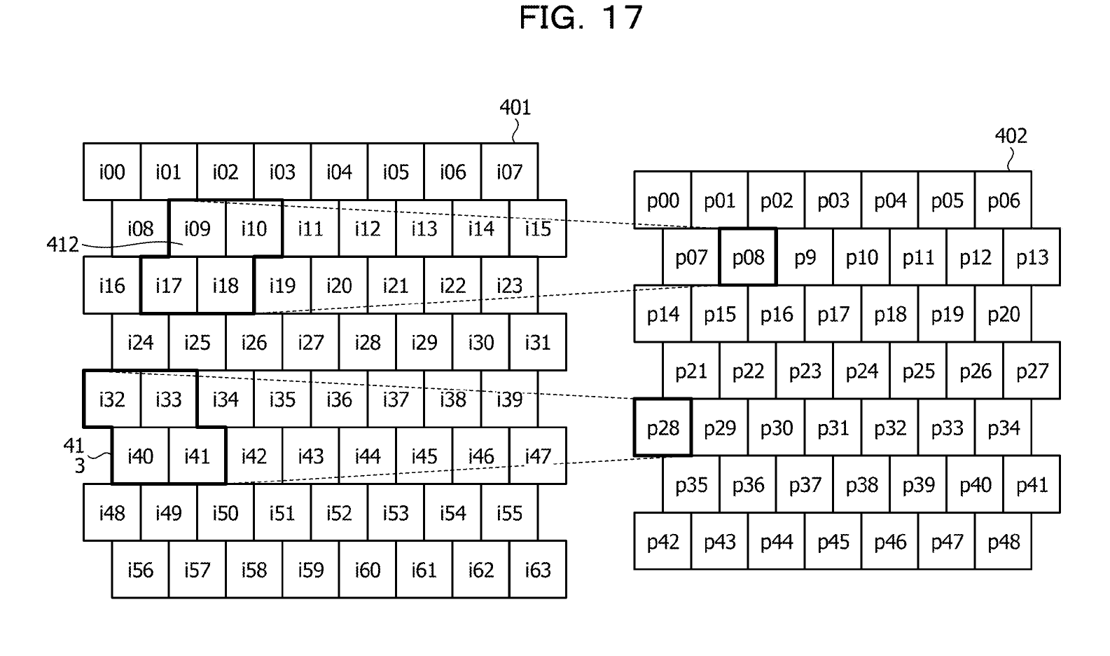

FIG. 17 illustrates an example of a pooling process by a pooling process unit for a case where the number of strides is one. In the case where the number of strides is one, the data to be subjected to the pooling is shifted by one row after each iteration of the process. Therefore, in a case where the data arrangement format is such as that of the data 401, two different pooling sizes are used.

The pooling process unit 103 stores pooling sizes defined by thick line frames 412 and 413 on the data 401 in FIG. 17. When the pooling process unit 103 calculates element data in odd-numbered rows of the data 402, the pooling process unit 103 uses the pooling size defined by the thick line frame 413. When the pooling process unit 103 calculates element data in even-numbered rows of the data 402, the pooling process unit 103 uses the pooling size defined by the thick line frame 412.

For example, first, the pooling process unit 103 places the thick line frame 413 such that a top row of the thick line frame 413 is overlaid on the first row of the data 401 and such that the thick line frame 413 is located on pieces of element data with smallest data numbers. The pooling process unit 103 then acquires element data i00, i01, i08, and i09 of the data 401 overlaid by the thick line frame 413, and performs the pooling process to acquire the average of the acquired pieces of element data or a maximum value thereof. The pooling process unit 103 employs the acquired value as element data p00 of the data 402 to be output. The pooling process unit 103 repeats the process of performing the pooling process and acquiring the value while shifting the thick line frame 413 in the row direction by an amount corresponding to one piece of element data until the thick line frame 413 reaches the end of the row of the data 401. The pooling process unit 103 then assigns the acquired values to the respective pieces of element data p01 to p06 of the data 402 to be output.

The pooling process unit 103 places the thick line frame 412 such that a top row of the thick line frame 412 is overlaid on the second row of the data 401 and such that the thick line frame 412 is located on pieces of element data with smallest data numbers. The pooling process unit 103 acquires element data i08, i09, i16, and i17 of the data 401 overlaid by the thick line frame 411, and performs the pooling process to acquire the average of the acquired pieces of element data or a maximum value thereof. The pooling process unit 103 employs the acquired value as element data p07 of the data 402 to be output. The pooling process unit 103 repeats the process of performing the pooling process and acquiring the value while shifting the thick line frame 412 in the row direction by an amount corresponding to one piece of element data until the thick line frame 412 reaches the end of the row of the data 401. The pooling process unit 103 assigns the acquired values to the respective pieces of element data p08 to p13 of the data 402 to be output.

The pooling process unit 103 repeatedly performs the process of acquiring the value by the pooling process while shifting down the row subjected to the process and alternately using the two pooling sizes. The pooling process unit 103 assigns the acquired values to the respective pieces of element data p14 to p48 of the data 402 to be output.

For example, when the thick line frame 412 is placed at a position on the data 401 as illustrated in FIG. 17, the pooling process unit 103 acquires element data i09, i10, i17, and i18. The pooling process unit 103 then acquires a value by performing the pooling process using the pieces of element data i19, i110, i17, and i18. Thereafter, the pooling process unit 103 employs the acquired value as the element data p08 of the data 402.

In a case where the thick line frame 413 is placed at a position on the data 401 as illustrated in FIG. 17, the pooling process unit 103 acquires element data i32, i33, i40, and i41. The pooling process unit 103 acquires a value by performing the pooling process using the pieces of element data i32, i133, i40, and i41. Thereafter, the pooling process unit 103 employs the acquired value as the element data p28 of the data 402.

The pooling process unit 103 acquires element data p00 to p48 thereby producing complete data 402. Thereafter, the pooling process unit 103 outputs the data 402 to a following operation processing layer 10.

As described above, the operation processing apparatus performs the pooling process directly using the top data given as a result of the forward convolution operation. Therefore, even in a case where the bottom data is converted to adapt to the new filter definition and the forward convolution operation is performed using the converted bottom data, it is possible to perform the pooling process without an increase in the process, and thus it possible to improve the overall computation efficiency of the network.

In a case where the bottom data is converted so as to adapt to the new filter definition, the operation processing apparatus performs padding such that the input data and the output data are equal in size. The operation processing apparatus that performs the padding may also be configured as illustrated in FIGS. 1 to 4. In the following description, a description of functions of elements similar to those of the operation processing apparatus described above may be omitted.

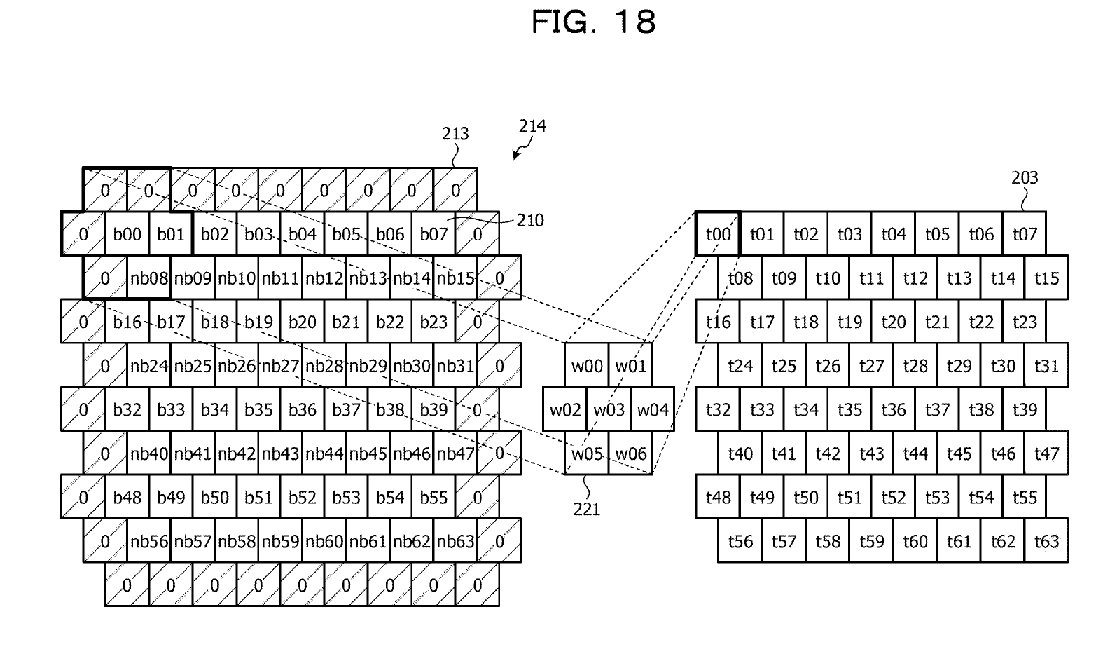

FIG. 18 illustrates an example of a forward convolution operation by the convolution operation unit. In this example, the forward convolution operation is performed using 8×8 bottom data 201 and weight data 221 using the new filter definition 301.

The input data processing unit 111 receives an input of the bottom data 201. The input data processing unit 111 converts the bottom data 201 to adapt to the new filter definition 301 and employs the resultant converted bottom data 201 as bottom data 210.

The input data processing unit 111 adds element data 213 with a value of 0 around the bottom data 210 as illustrated in FIG. 18 thereby producing bottom data 214. The process of adding the element data 213 with the value of 0 around the bottom data 210 is referred to as 0-padding. By the 0-padding, the input data processing unit 111 obtains the bottom data 210 having the same size as the size of the top difference data 203. The input data processing unit 111 outputs the bottom data 214 to the multiplication operation unit 112.

The multiplication operation unit 112 receives an input of the bottom data 214 from the input data processing unit 111. The multiplication operation unit 112 executes a forward convolution operation on the bottom data 214 using the weight data 221. Thus, the multiplication operation unit 112 calculates as many pieces of element data t00 to t63 of the top data 209 as the number of pieces of element data b00 to nb63 included in the bottom data 210.

In this calculation, in a case where the bottom data 201 includes 8×8 elements arranged in a matrix, 36 pieces of element data 213 are used in the 0-padding. On the other hand, for the bottom data 210, 34 pieces of element data 213 are used in the 0-padding. For example, when the bottom data 210 is used, the number of pieces of element data 213 used in the 0-padding is smaller than in the case where the unconverted bottom data 201 is used.

As described above, the operation processing apparatus performs the 0-padding on the bottom data having been subjected to the conversion to adapt to the new filter definition, and the operation processing apparatus performs the forward convolution operation using the resultant bottom data. In this case, the number of pieces of element data to be added is smaller than in the case where the 0-padding is performed on the unconverted bottom data, and thus it is possible to achieve a reduction in data size and an improvement in the computation efficiency.

The operation processing apparatus performs the forward convolution operation and the backward convolution operation on three-dimensional data using a new filter definition. The operation processing apparatus that performs the operation on three-dimensional data may also be configured as illustrated in FIGS. 1 to 4. Each element has a function of performing a process on three-dimensional data in a similar manner to a corresponding element denoted by a similar symbol in FIGS. 1 to 4.

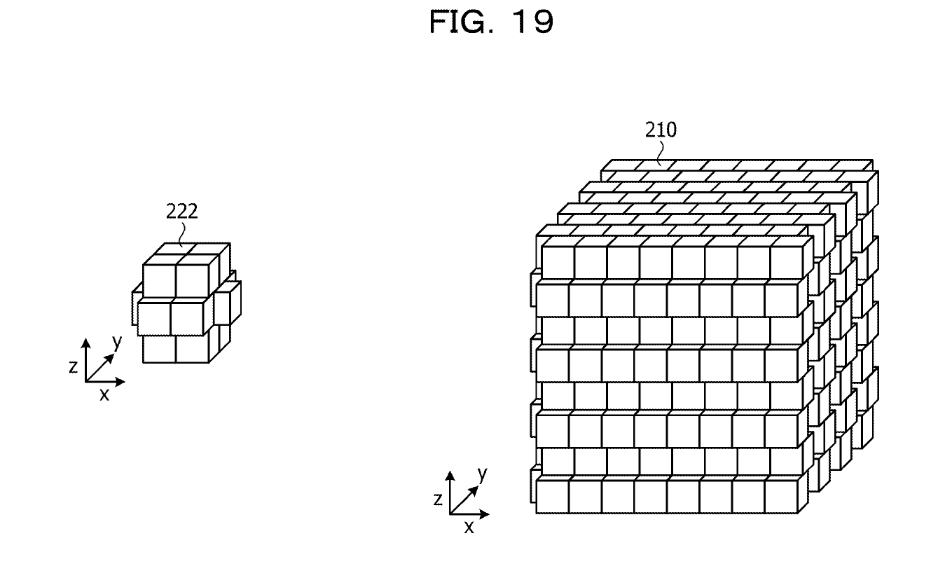

FIG. 19 illustrates an example of a forward convolution operation by the convolution operation unit using a new filter definition. The weight data storage unit 115 stores weight data 222 using three-dimensional new filter definition. A conventional filter definition for use with the weight data 222 includes 3×3×3 pieces of element data arranged in a cube. The data arrangement form of the weight data 222 as seen in the x- or z-axis direction is similar to the data arrangement form of the new filter definition 301 according to the first embodiment.

The input data processing unit 111 receives an input of the bottom data 201 including 8×8×8 pieces of element data arranged in a cube. The input data processing unit 111 averages element data of the bottom data 201 adjacent in a y-axis direction and in a z-axis direction in a coordinate system illustrated in FIG. 19 whereby the input data processing unit 111 produces bottom data 210 having an appearance in which, with reference to element data positions of the bottom data 201, element data positions in every other row are shifted in the y-axis direction and the z-axis direction by an amount corresponding to one-half the size of one piece of element data. The input data processing unit 111 outputs the produced bottom data 210 to the multiplication operation unit 112.

The multiplication operation unit 112 receives an input of the bottom data 210. The multiplication operation unit 112 performs a forward convolution operation in which the weight data 222 using the new filter definition is applied to the bottom data 210.

Furthermore, the convolution operation unit 106 receives an input of the top difference data 203 having a data arrangement form similar to that of the top data 209 calculated in the forward convolution operation using the bottom data 210 and the weight data 223. The convolution operation unit 106 performs the backward convolution operation using the bottom data 210, the weight data 222, and the acquired top difference data 203.

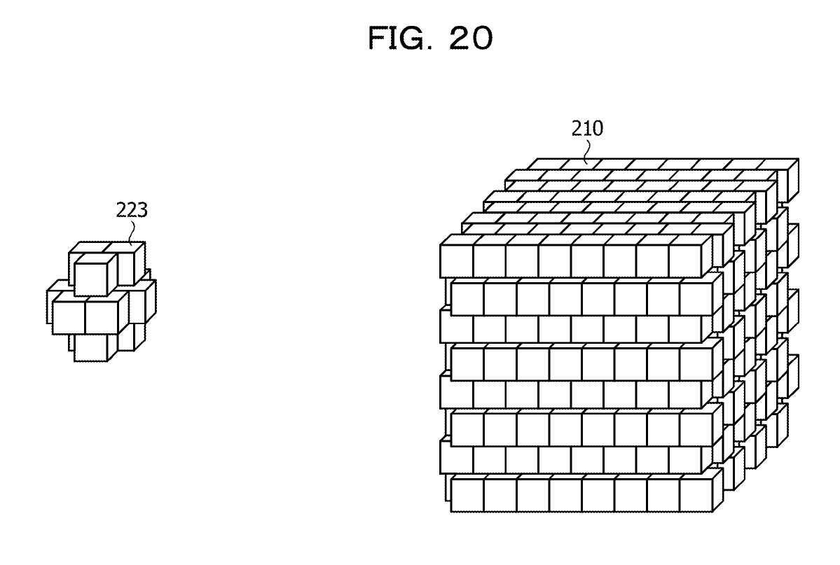

FIG. 20 illustrates an example of a forward convolution operation by the convolution operation unit using the new filter definition. The weight data storage unit 115 stores weight data 223 using three-dimensional new filter definition. Also this weight data 223 employs a new filter definition including 3×3×3 pieces of element data arranged in a cube. The data arrangement form of the weight data 223 as seen in the x- or z-axis direction is similar to the data arrangement form of the new filter definition 301 according to the first embodiment.

The input data processing unit 111 produces bottom data 210 in a similar manner as illustrated in FIG. 19. The multiplication operation unit 112 performs a forward convolution operation in which the weight data 223 using the new filter definition is applied to the bottom data 210. The convolution operation unit 106 performs a backward convolution operation using the top difference data 203 having a data arrangement form similar to that of the top data 209 calculated in the forward convolution operation using the bottom data 210 and the weight data 223.

As described above, also in the case where three-dimensional data is treated, the operation processing apparatus performs the forward convolution operation and the backward convolution operation using the new filter definition including a smaller number of pieces of element data than is used in the conventional technique. Thus, in the deep learning operation using three-dimensional data, the operation processing apparatus is capable of improving the computation efficiency while suppressing the capacity of the storage apparatus used.

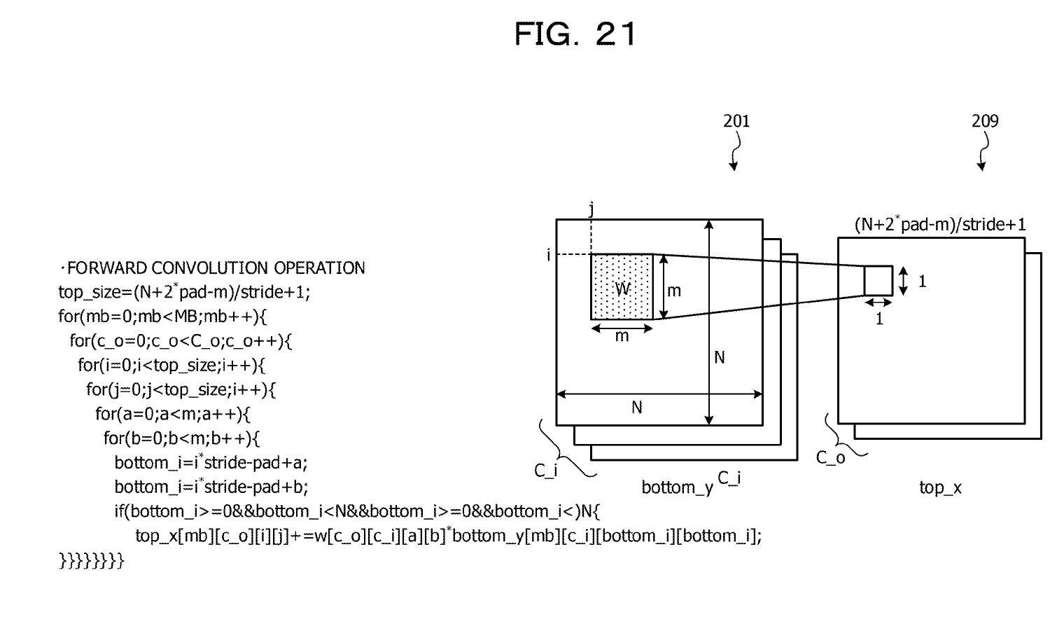

FIG. 21 illustrates an example of a description of program of a forward convolution operation. In the forward convolution operation, the operation using the bottom data 201 (bottom_y) and the top data 209 (top_x) can be represented by a multiplication operation and an addition operation as illustrated in FIG. 21. The forward convolution operation is performed for specified parameters including the number, Ci, of pieces of data of the bottom data 201, the number, Co, of pieces of data of the top difference data 203, the number of batches mb, the number of strides W, and the number of pads which is a parameter for adjusting the top size. The adjustment of the top size may correspond to padding of the top size.

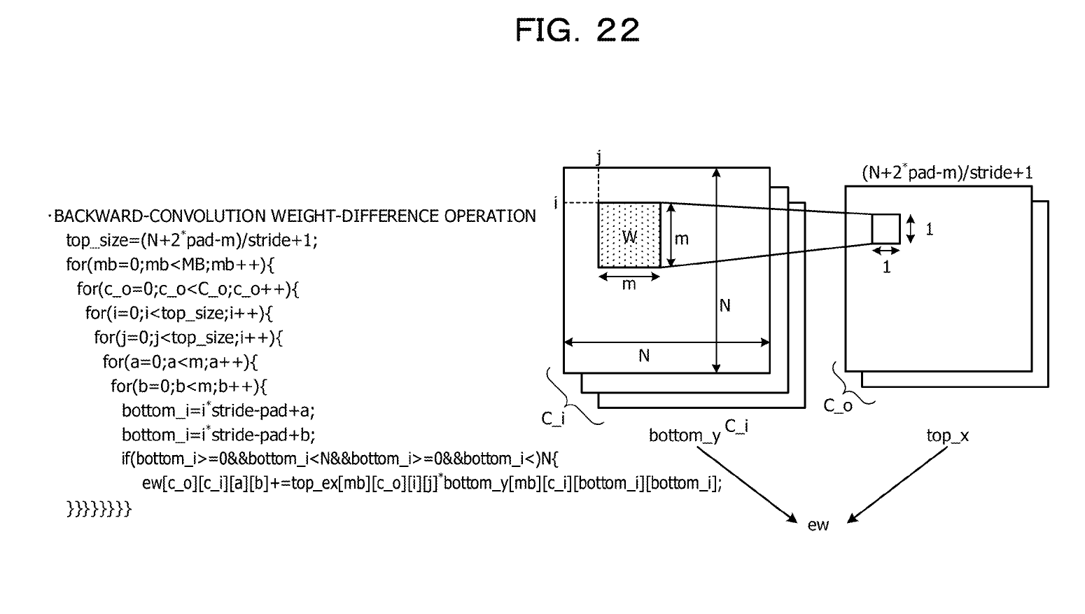

FIG. 22 illustrates an example of a description of program of a backward-convolution weight-difference operation. In the backward-convolution weight-difference operation, the operation using the bottom data 201 (bottom_y) and the top data 203 (top_x) can be represented by a multiplication operation and an addition operation as illustrated in FIG. 22. In this case, weight difference data (ew) is calculated. The backward-convolution weight-difference operation is performed for specified parameters including the number, Ci, of pieces of data of the bottom data 201, the number, Co, of pieces of data of the top difference data 203, the number of batches mb, the number of strides W, and the number of pads which is a parameter for adjusting the top size. Here, the adjustment of the top size may correspond to padding of the top size.

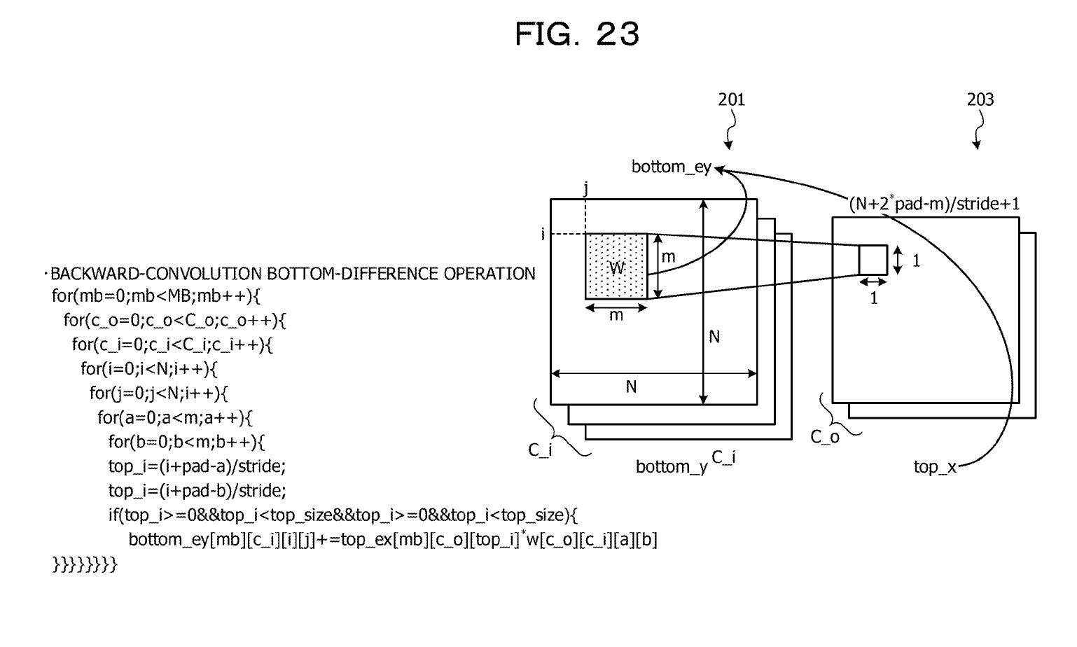

FIG. 23 illustrates an example of a description of a program of a backward-convolution bottom-difference operation. In the backward-convolution bottom-difference operation, the operation using the bottom data 201 (bottom_y) and the top data 203 (top_x) can be represented by a multiplication operation and an addition operation as illustrated in FIG. 23. In this case, bottom difference data 205 (bottom_ey) is calculated. The backward-convolution bottom-difference operation is performed for specified parameters including the number, Ci, of pieces of data of the bottom data 201, the number, Co, of pieces of data of the top difference data 203, the number of batches mb, the number of strides W, and the number of pads which is a parameter for adjusting the top size. Here, the adjustment of the top size may correspond to padding of the top size.

FIG. 25 illustrates an example of hardware of an operation processing apparatus. The operation processing apparatus 1 includes a CPU (Central Processing Unit) 91, a memory 92, an accelerator 93, and a memory 94. The memory 92 is a memory dedicated to use by the CPU 91 and may be included in the CPU 91. The memory 94 is a memory for use by the accelerator 93 and may be included in the accelerator 93.

The memory 92 stores various programs including an OS (Operating System) and a learning program used by each operation processing layer 10. The memory 92 also stores input data 2 and an expectation value 207.

The CPU 91 executes the OS stored in the memory 92. Furthermore, the CPU 91 outputs various kinds of programs including the learning program and various kinds of data including the input data 2, the weight data 202, and the expectation value 207 stored in the memory 92 to the accelerator 93. The weight data 202 includes weight data 221 or the like depending on the new filter definition to be used. The CPU 91 instructs the accelerator 93 to execute a deep learning process. Thereafter, the CPU 91 acquires the learned weight data 202 from the accelerator 93, and updates the weight data 202 stored in the memory 92.

The accelerator 93 is, for example, GPU, FPGA (Field Programmable Gate Array), or the like. The accelerator 93 stores, in the memory 94, various kinds of program including the learning program input from the CPU 91 and various kinds of data including the input data 2 and the expectation value 207. The accelerator 93 then executes a deep learning process using various kinds of programs including the learning program and various kinds of data stored in the memory 94. Thus, the accelerator 93 realizes the respective functions of the convolution operation unit 101, the activation process unit 102, the pooling process unit 103, the pooling process unit 104, the activation process unit 105, and the convolution operation unit 106 of the operation processing layer 10 illustrated by way of example in FIG. 2. The accelerator 93 outputs weight data 202 obtained as a learning result in each operation processing layer 10 to the CPU 91. The accelerator 93 performs processing in a similar manner for all operation processing layers 10. The accelerator 93 may acquire data from the CPU 91 for each process by each operation processing layer 10 or may acquire all data to be used in the operation processing layers 10 at a time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An operation processing apparatus comprising:
a processor; and
a memory coupled to the processor and configured to store a program,
the processor, according to the program, performs:
acquiring first data and second data from the memory in which the first data and second data are stored, the first data including pieces of element data arranged in the form of a matrix, the second data having an arrangement form obtained by removing a specific number of pieces of element data from the pieces of element data;
converting the first data based on the arrangement form of the second data; and
executing a convolution operation on the converted first data using the second data as a filter.

2. The operation processing apparatus according to claim 1, wherein the second data has an arrangement form symmetric in vertical, horizontal, and diagonal directions.

3. The operation processing apparatus according to claim 1, wherein
the first data in which a number of first pieces of element data included in the pieces of element data and arranged in a row direction is equal to a number of second pieces of element data included in the pieces of element data and arranged in a column direction,
the second data is obtained by removing one piece of element data from each of rows across a center row one by one in a direction apart from the center row, and by shifting a position of the element data after removing such that the center of the element data after removing coincides with the center of the element data before removing, and
the processor converts the first data such that each two adjacent pieces of element data in every other row are averaged.

4. The operation processing apparatus according to claim 1, wherein the processor executes:
a pooling process using values of respective pieces of element data included in a result of the convolution operation.

5. The operation processing apparatus according to claim 1, wherein the processor executes:
adding a minimum number of pieces of element data each having a value of 0 to the first data such that the first data is surrounded by the added pieces of element data;
a convolution operation on the first data including the added pieces of element data using the second data as a filter; and
acquiring a convolution operation result including pieces of element data whose number is equal to a number of pieces of element data included in the first data.

6. An operation processing method comprising:
acquiring, by a computer, first data and second data from the memory in which the first data and second data are stored, the first data including pieces of element data arranged in the form of a matrix, the second data having an arrangement form obtained by removing a specific number of pieces of element data from the pieces of element data;
converting the first data based on the arrangement form of the second data; and
executing a convolution operation on the converted first data using the second data as a filter.

7. The operation processing method according to claim 6, wherein the second data has an arrangement form symmetric in vertical, horizontal, and diagonal directions.

8. The operation processing apparatus according to claim 6, wherein the first data in which a number of first pieces of element data included in the pieces of element data and arranged in a row direction is equal to a number of second pieces of element data included in the pieces of element data and arranged in a column direction,
the second data is obtained by removing one piece of element data from each of rows across a center row one by one in a direction apart from the center row, and by shifting a position of the element data after removing such that the center of the element data after removing coincides with the center of the element data before removing, and
the first data is converted such that each two adjacent pieces of element data in every other row are averaged.

9. The operation processing method according to claim 6, further comprising:
executing a pooling process using values of respective pieces of element data included in a result of the convolution operation.

10. The operation processing method according to claim 6, further comprising:
adding a minimum number of pieces of element data each having a value of 0 to the first data such that the first data is surrounded by the added pieces of element data;
executing a convolution operation on the first data including the added pieces of element data using the second data as a filter; and
acquiring a convolution operation result including pieces of element data whose number is equal to a number of pieces of element data included in the first data.
